(19) United States
(12) Patent Application Publication
(10) Pub. No.: US 2025/0222460 A1
(43) Pub. Date: Jul. 10, 2025

(54) FIELD-DEPLOYABLE DEVICES, SYSTEMS, AND METHODS FOR ISOTHERMAL ASSAY TESTING AND KITS THEREFORE

(71) Applicant: Purdue Research Foundation, West Lafayette, IN (US)

(72) Inventors: Mohit S. Verma, West Lafayette, IN (US); Nafisa Rafiq, West Lafayette, IN (US); Bibek Raut, Dhodhana Birnagar (NP)

(21) Appl. No.: 19/010,865

(22) Filed: Jan. 6, 2025

Related U.S. Application Data
(60) Provisional application No. 63/617,916, filed on Jan. 5, 2024.

(51) Int. Cl. B01L 7/00

(52) U.S. Cl. CPC B01L 7/52; B01L 2200/04; B01L 2200/147; B01L 2300/025; B01L 2300/043; B01L 2300/0663; B01L 2300/126; B01L 2300/1805; B01L 2300/185

(57) ABSTRACT

Field-deployable devices, systems, and methods are provided for performing isothermal assays in a protected environment that can be heated and held at a consistent temperature. Kits are also provided that include the devices and systems hereof.

### PRIORITY

This application is related to and claims the priority benefit of U.S. Provisional Patent Application No. 63/617,916 filed Jan. 5, 2024. The content of the aforementioned application is hereby incorporated by reference in its entirety into this disclosure.

### STATEMENT OF GOVERNMENT SUPPORT

This invention was made with government support under (1) FF-NIA20-0000000087 and ICASATWG-0000000022 awarded by the Foundation for Food and Agriculture Research; (2) Agriculture and Food Research Initiative Competitive Grants Program Award 2020 68014 31302awarded by the United States Department of Agriculture; and (3) AP22VSD&B000C022 awarded by the United States Department of Agriculture's Animal and Plant Health Inspection Service through the National Animal Health Laboratory Network. The government has certain rights in the invention.

### TECHNICAL FIELD

The present disclosure generally relates systems and methods for providing a field-deployable water bath for isothermal assay testing.

### BACKGROUND

This section introduces aspects that may help facilitate a better understanding of the disclosure. Accordingly, these statements are to be read in this light and are not to be understood as admissions about what is or is not prior art.

Isothermal assay principles are based on the use of DNA polymerases with strand displacement activity to amplify nucleic acids at a constant temperature, typically between about 37° C.-65° C. Isothermal assays can be used for detecting contamination of fresh produce, among other applications.

Loop-mediated isothermal amplification (LAMP) is one such isothermal molecular method for rapid detection of nucleic acids. Notomi et al., Loop-mediated isothermal amplification of DNA, Nucleic Acids Research 28: e63-e63 (2000); Nzelu et al., Loop-mediated isothermal amplification (LAMP): An advanced molecular point-of-care technique for the detection of Leishmania infection, PLOS Neglected Tropical Diseases 13: e0007698 (2019); Sirichaisinthop et al., Evaluation of loop-medited isothermal amplification (LAMP) for malaria diagnosis in a field setting, Am J Tropical Medicine & Hygiene 85:594 (2011); Conrad et al., A sensitive and accurate recombinase polymerase amplification assay for detection of the primary bacterial pathogens causing bovine respiratory diseases, Frontiers in Veterinary Science 7:208 (2020); Mohan et al., Loop-mediated isothermal amplification for the detection of Pasteurella multocida, Mannheimia haemolytica, and Histophilus somni in bovine nasal samples, ACS Agricultural Science & Technology 1:100-108 (2021). Although LAMP is not as common as polymerase chain reaction (PCR) for detecting pathogens, it can accomplish the detection in under an hour and does not require a thermal cycler. Kozel & Burnham-Marusich, Point-of-care testing for infectious diseases: past, present, and future, J Clinical Microbiology 55:2313-2320 (2017).

In a LAMP assay, the samples are heated at a constant temperature for a period of time, such as, for example, 60 minutes, which causes the amplification of the nucleic acid. Mori et al., Real-time turbidimetry of LAMP reaction for quantifying template DNA, J Biochemical & Biophysical Methods 59:145-157 (2004); Nagamine et al., Accelerated reaction by loop-mediated isothermal amplification using loop primers, Molecular & Cellular Probes 16:223-229 (2002); Tomita et al., Loop-mediated isothermal amplification (LAMP) of gene sequences and simple visual detection of products, Nature Protocols 3:877-882 (2008). Based on the presence of the target gene from the microbe, a change in fluorescence, turbidity, and/or color can be observed after heating for less than an hour. Mori et al., Detection of loop-mediated isothermal amplification reaction by turbidity derived from magnesium pyrophosphate formation, Biochemical & Biophysical Research Communications 289:15-154 (2001); Parida et al., Loop mediated isothermal amplification (LAMP): a new generation of innovative gene amplification technique; perspectives in clinical diagnosis of infectious diseases, Reviews Med Virology 18:407-421 (2008).

There are many water-based heating devices available that can be used to heat isothermal test samples (e.g., in a field setting). For example, circulating water baths have been used to maintain a constant and uniform temperature for biological assays. Tyler et al., Environmental temperature sensing using Raman spectra DTS fiber-optic methods, Water Resources Research 45 (2009); Wang et al., Postharvest treatment to control codling moth in fresh apples using water assisted radio frequency heating, Postharvest Biology & Technology 40:89-96 (2006). However, it is typically difficult to view the biological assays (i.e. the results thereof) when submerged in conventional water-bath devices. In addition, although researchers used different types of precision heating devices to heat water while performing LAMP, conventional devices all require the user to immerse their hands into hot water to place the samples. Kellner et al., Scalable, rapid and highly sensitive isothermal detection of SARS-COV-2 for laboratory and home testing, BioRxiv 10:23.166397 (2020); Pascual-Garrigos et al., On-farm colorimetric detection of Pasteurella multocida, Mannheimia haemolytica, and Histophilus somni in crude bovine nasal samples, Veterinary Research 52:1-12 (2021); Peltzer et al., Rapid and simple colorimetric loop-mediated isothermal amplification (LAMP) assay for the detection of Bovine alpha herpes virus 1, J Virological Methods 289:114041 (2021).

Accordingly, there is a need for a flexible water bath that can be easily deployed in the field without risking contamination, that does not require a user to touch hot water when interacting with the samples to be tested and allows for visual tracking of sample amplification.

### SUMMARY

Generally, the present disclosure provides a reaction system for isothermal amplification assays. The reaction system can comprise a sample loading unit for housing one or more assay samples, a controller in electrical communication with a heater, a power supply coupled with the heater, controller, or both the heater and controller, and a chamber. In certain embodiments, the cartridge of the sample loading unit defines a substantially waterproof environment in which the one or more sample holders is housed.

The chamber can comprise two or more outer walls defining an interior for holding fluid therein and an open top in communication with the interior. The chamber can further comprise a lid. The lid can define at least a first inlet in communication with the interior of the chamber and can be configured to seat over the open top of the chamber. In certain embodiments, the lid further comprises at least one area for supporting the controller of the system. The first inlet of the lid can be configured to receive at least a portion of the sample loading unit therethrough. Further, at least a portion of the two or more outer walls of the chamber can be transparent and the heater can be positioned to heat fluid within the interior of the chamber. The lid can further comprise a housing for encasing at least the controller. In certain embodiments, the lid is hingedly coupled with at least one of the two or more outer walls of the chamber. In certain embodiments, the lid is integrally formed with at least one of the two or more outer walls of the chamber. The lid can be configured to seal the interior of the chamber when positioned over the open top of the chamber (i.e., be configured to sealably seat over the open top). Alternatively, the lid can be configured such that, when positioned over the open top of the chamber, the interior is substantially closed, but not necessarily sealed.

In certain embodiments, the heater is an immersion heating device, the fluid is water, and the lid further comprises a second inlet in communication with the interior and configured to receive at least a portion of the heater therethrough. Alternatively, the heater can comprise a solid-state heater. There, the fluid can be air.

The sample loading unit can comprise a handle coupled with a cartridge comprising one or more sample holders. Each sample holder can be, for example, configured to receive, secure, and display an assay container or paper strip assay therein.

In certain embodiments, the reaction system further comprises an imaging device positioned to capture images of the one or more sample holders through the transparent outer wall portion when the sample loading unit is inserted into the interior of the chamber via the first inlet. The imaging device can be a camera or a scanner, for example. The imaging device can be in communication with the controller of the system. The imaging device can comprise a Raspberry Pi camera with autofocus capability.

The system can further comprise a submergible circulator or fan configured to circulate fluid within the interior of the chamber. In certain embodiments, the circulator is a submergible motor and the fluid comprises water. In certain embodiments, the circulator is a fan and the fluid comprises air. The circulator can be in communication with the controller and, for example, controlled thereby.

The controller can comprise a microcontroller. The controller can further comprise a display and input region, each in communication with the microcontroller to display at least the current temperature of the interior of the chamber and enable a user to set a target temperature of fluid within the interior of the chamber.

In certain embodiments, the system further comprises a temperature sensor in communication with the controller and for placement within the interior of the chamber. The temperature sensor can be used to monitor the current temperature of the fluid within the interior of the chamber.

Methods are also provided for performing an isothermal amplification assay using the reaction systems hereof. In certain embodiments, the method comprises providing a reaction system for isothermal amplification assays, the reaction system comprising: a sample loading unit for housing one or more assay samples, the sample loading unit comprising a handle coupled with a cartridge comprising one or more sample holders, each sample holder configured to receive, secure, and display an assay container or paper strip assay therein; a controller in electrical communication with a heater; a power supply coupled with the heater, controller, or both the heater and controller; and a chamber comprising: two or more outer walls defining an interior for holding fluid therein and an open top in communication with the interior, and a lid defining at least a first inlet in communication with the interior, wherein the lid is configured to seat over the open top of the chamber and further comprises at least one area for supporting the controller, wherein the first inlet is configured to receive the testing unit therethrough, at least a portion of the two or more outer walls is transparent, and the heater is positioned to heat fluid within the interior of the chamber. The method can further comprise activating the heater to heat fluid within the interior of the chamber to a target temperature; inserting the cartridge of the sample loading unit into the interior of the chamber and fluid contained therein, wherein the cartridge secures and displays one or more paper-based or tube isothermal assays; and maintaining the fluid at the target temperature to incubate the isothermal assays.

The target temperature can be 37-85 degrees Celsius, and the fluid can be water or air. The target temperature can be, for example, obtained within about 12 minutes from activating the heater using the reaction systems hereof.

In certain embodiments, the method further comprises capturing timelapse images through a transparent portion of the outer wall of the chamber of the isothermal assays secured and displayed within the cartridge using an imaging device. The imaging device can be any device described herein in connection with the reaction system, or otherwise that could be useful therewith.

The method can further comprise processing the timelapse images using the controller of the reaction system (e.g., executing software stored thereon) to obtain quantitative colorimetric data from the assays. The method can further comprise displaying the results (e.g., using a display of the controller) to a user.

Kits are also provided. In certain embodiments, a kit for performing a field-deployable isothermal amplification assay is provided. The kit can comprise a reaction system for isothermal amplification assays described herein. In certain embodiments, the reaction system of the kit comprises: a sample loading unit for housing one or more assay samples, the sample loading unit comprising a handle coupled with a cartridge comprising one or more sample holders, each sample holder configured to receive, secure, and display an assay container or paper strip assay therein; a controller in electrical communication with a heater; a power supply coupled with the heater, controller, or both the heater and controller; and a chamber comprising: two or more outer walls defining an interior for holding fluid therein and an open top in communication with the interior, and a lid defining at least a first inlet in communication with the interior, wherein the lid is configured to seat over the open top of the chamber and further comprises at least one area for supporting the controller. The first inlet can be configured to receive the testing unit therethrough, at least a portion of the two or more outer walls can be transparent, and the heater can be positioned to heat fluid within the interior of the chamber. The kit can further comprise one or more assay sensors. In certain embodiments, the assay sensors can comprise a paper-based strip assay sensor. In certain embodiments, the assay sensors can comprise a tube/container-based assay sensor. The kits hereof can further comprise one or more devices, such as a cotton swab, for obtaining a sample from a test subject.

### BRIEF DESCRIPTION OF DRAWINGS

The disclosed embodiments and other features, advantages, and aspects contained herein, and the matter of attaining them, will become apparent in light of the following detailed description of various exemplary embodiments of the present disclosure. Such detailed description will be better understood when taken in conjunction with the accompanying drawings.

FIG. 1 is a schematic diagram representative of a reaction system hereof.

FIG. 2 is a schematic model representative of a reaction system hereof, including electrical communications between various elements and details with respect to the electrical components of certain embodiments of the control system, power supply, and heating element.

FIGS. 3A and 3B show, respectively, an assembled lid of the reaction system and a base of the lid defining at least a first inlet and a second inlet.

FIG. 3C shows a cover for use with the lid configured to cover at least the first inlet (e.g., loading slot) of the lid.

FIG. 3D shows a housing of the lid for encasing the control system and/or electrical components thereof.

FIG. 3E shows a plate of the lid configured to support the heating element and that defines the second inlet.

FIGS. 3F-3I show various embodiments of sample loading units, with FIG. 3F showing a side view of a sample loading unit configured to receive and display paper assay samples, FIG. 3G showing a bottom view of the sample loading unit of FIG. 3F, FIG. 3H showing a side view of a sample loading unit configured to receive and display both paper and/or liquid samples, and FIG. 3I showing a bottom view of the sample loading unit of FIG. 3H.

FIG. 4 is a photograph of a reaction system hereof, with a transparent chamber (on left) holding a liquid (water), the white housing (on right) encasing the electrical components of the control system.

FIG. 5 is a photograph (top view) of a lid of the reaction system of FIG. 4 comprising a first inlet (e.g., loading slot) through which a sample loading unit holding one or more isothermal assay samples can be inserted into the interior of the chamber (e.g., water bath).

FIG. 6 is a photograph of a display (e.g., an LCD touch screen display) of the control system that can display temperature results.

FIGS. 7A-7C show various sample loading units for use with the reaction system. FIG. 7A is a 3D model of a sample loading unit for use with both cartridge and tube assay samples, FIG. 7B shows a first side of a sample loading unit for use with both cartridge and paper-based assay samples, and FIG. 7C shows a second side of the unit of FIG. 7B configured for use with individual tubes for liquid-based assay samples.

FIG. 8 shows images of a reaction system with various sample loading units and screenshots user interfaces of the control system at various software operation settings, with (a) showing a top view of the reaction system; (b) showing a front view of the reaction system; (c) showing a side view of the reaction system and chamber thereof; (d) showing various sample loading units for use with the chamber; (e) showing a screenshot of a user interface of the control system when the system is in standby mode; (f) showing a screenshot of a user interface of the control system after a target temperature is set (e.g., using a display); (g) showing a screenshot of a user interface of the control system after a user presses “start” to initiate a reaction cycle; (h) showing a screenshot of a user interface of the control system halfway through the fluid in the chamber reaching the target temperature; and (i) and (j) showing screenshots of a user interface of the control system when the controller is maintaining the target temperature.

FIGS. 9A-9B show graphs of the temperature fluctuation in different environments after reaching the target temperature (FIG. 9A) and variation of time for precision cooker and chamber of the reaction system to reach the target temperature while heating 6 liters of water (FIG. 9B).

FIGS. 10A-10C show thermal images of different points of water after reaching the target temperature (65° C.) using the reaction system (FIG. 10A), a single point at an arbitrary time after reaching the target temperature (65° C.) using the reaction system (FIG. 10B), and the water heated using an Anova convention precision cooker after reaching the target temperature (65° C.) (FIG. 10C).

FIG. 11 shows representative steps of performing a colorimetric loop-mediated isothermal amplification (LAMP) assay using the reactive system hereof. Positive samples had the presence of the target DNA and negative samples had nuclease-free water instead of the target DNA. The images of the tube holders holding the liquid samples shown were taken while the liquid samples were submerged inside the water bath using a sample loading unit at (a) t=0 minutes, before heating, (b) t=60 minutes, after heating for 60 minutes, (c) t=0 minutes, before heating, and (d) t=60 minutes, after heating for 60 minutes. The images of the paper samples shown were taken while the paper samples were submerged inside the water bath using a sample loading unit at (e) t=0 minutes, before heating and (f) t=60 minutes, after heating for 60 minutes.

FIG. 12 is a time versus temperature plot of water heated in the chamber of the reaction system hereof from 22° C. to 65°° C. (top) and a graph of temperature fluctuation over time in the same chamber after reaching the target temperature (65° C.) (bottom).

FIG. 13 relates to a paper-based LAMP experiment run using the reaction system hereof comprising a sample loading unit comprising a cartridge holder, with (a) showing images of submerged assay samples placed in positions C, D, E, F, G, H, and I of the holder, the images captured by a simple camera placed outside of the chamber (i.e. taken through the transparent portion of the chamber) at two different time points (0 minutes and 60 minutes relative to submersion in the water bath), (b) showing a photograph of the reaction system in use, and (c) being a graph of data related to the experiment parameters.

FIG. 14 shows graphs of reaction percentage over time (unsmoothed) of position C of the experiment of FIG. 13 (top), which had three replicates of a negative control (NTC), and of position H of the experiment of FIG. 13 (bottom), which had three replicates of 10⁵ copies/reaction.

FIG. 15 relates to a liquid LAMP experiment run using the reaction system hereof comprising a sample loading unit comprising a tube holder, with (a) showing images of submerged assay samples placed in positions B, C, D, E, F, and G of the holder, the images captured by a simple camera placed outside of the chamber (i.e. taken through the transparent portion of the chamber) at two different time points (0 minutes and 60 minutes relative to submersion in the water bath), (b) showing a photograph of the reaction system in use, and (c) being a graph of data related to the experiment parameters.

FIG. 16 shows graphs of reaction percentage over time (unsmoothed) of position B of the experiment of FIG. 15 (top), which had two replicates of 1000 copies/reaction, and of position G of the experiment of FIG. 15 (bottom), which had two replicates of NTC.

FIG. 17 is a photograph illustrating a step of a method for fabricating a sample loading unit comprising a leak-proof or resistant cartridge for paper-based sensors.

FIG. 18 are photographs illustrating representative steps of a method for running an isothermal assay using the reaction system hereof and an imaging device comprising a flat-bed scanner.

FIG. 19 relates to processing the images taken in the experiment of FIG. 18 and includes (a) an image of the assay samples submerged in the water bath of the chamber, the images captured by the flat-bed scanner placed outside of the chamber (i.e. taken through a transparent portion of the outer wall of the chamber); (b) a hue versus pH graph of sample values taken at 0 minutes of heating; and (c) a calibration curve for the target gene ORF7ab gene obtained using the hue color evaluation of the time series image data of (a) and (b).

FIG. 20 shows a schematic of a reaction system hereof comprising a backlight for illuminating the interior of the chamber and a camera coupled with the exterior of the chamber, and photographs illustrating representative steps of a method for running an isothermal assay using the reaction system hereof with the backlight.

FIG. 21A relates to a liquid-tube based PCR assay run using the reaction system of FIG. 19 on human stool samples and includes (a) a reaction time versus log concentration of the samples; (b) an image of the assay samples submerged in the water bath of the chamber, the images captured by the camera placed outside of the chamber (i.e. taken through a transparent portion of the outer wall of the chamber) and illuminated by the backlighting of the interior of the chamber; and (c) a table of the experiment parameters.

FIG. 21B relates to a paper-based assay run using the reaction system of FIG. 19 to detect the presence of a tetH gene and includes (a) a reaction time versus log concentration of the samples; (b) an image of the assay samples submerged in the water bath of the chamber, the images captured by the camera placed outside of the chamber (i.e. taken through a transparent portion of the outer wall of the chamber) and illuminated by the backlighting of the interior of the chamber; and (c) a table of the experiment parameters.

FIG. 22 shows schematics of a Smartphone-sized reaction system hereof comprising an indium tin oxide (ITO)-coated glass heater comprising a heating surface, a Raspberry Pi camera with autofocus ability, and backlight illumination of the interior of the chamber, and a photograph illustrating the reaction device.

FIG. 23 is a schematic of Smartphone-sized reaction system employing an ITO-coated glass heater, photodiode color sensor, and backlight illumination.

FIG. 24 are examples of graphical user interfaces that can be used with the control system of the reaction system to facilitate user interaction and/or image processing in furtherance of obtaining quantitative reaction results, for example.

FIG. 25 are LAMP reaction plots showing raw amplification data, which was smoothed using Gaussian function (alpha=2), followed by calculation of first and second derivatives. The x-value (time in minutes) corresponds to the second derivative maxima, which was used to determine reaction time. The DNA/RNA template concentration was then determined based on a calibration curve previously generated.

While the present disclosure is susceptible to various modifications and alternative forms, exemplary embodiments thereof are shown by way of example in the drawings and are herein described in detail.

### DETAILED DESCRIPTION

While the concepts of the present disclosure are illustrated and described in detail in the description herein, results in the description are to be considered as exemplary and not restrictive in character; it being understood that only the illustrative embodiments are shown and described and that all changes and modifications that come within the spirit of the disclosure are desired to be protected.

The present disclosure generally relates to field-deployable reaction systems for isothermal amplification assays. The reaction systems enable a simple method of nucleic amplification, where the reaction can be performed within a fluid chamber (e.g., a water bath or using a heating surface) at a constant temperature and output provided as visible results viewable by the naked eye or a simple camera device (e.g., a colorimetric format). The reaction systems can be portable (i.e. configured for use in laboratory and non-laboratory spaces), have uniform heat distribution throughout the chamber when heated, and allow a user to observe continuous changes in the color of assay samples. Tracking the color changes over time has the potential to enable a quicker response for samples with higher concentrations of the target and/or provide quantitative data regarding the concentration of target in the sample (e.g., using image analysis algorithms).

Generally, with isothermal assays, a sample is heated over a specific period (e.g., with loop-mediated isothermal amplification (LAMP), typically less than one hour) at a constant temperature to facilitate nucleic acid amplification. The amplification of target nucleic acids can be observed visually as a change in turbidity or color. Mori et al. (2001), supra; Parida et al. (2008), supra. This amplification can be performed, for example, using a water bath. Parida et al. (2008), supra. In developing the present reaction system, a precision cooker was initially used to heat the water bath for performing LAMP assays. Pascual-Garrigos et al. (2021), supra. There, the chamber was not sealed, and the samples were taped to a wall of the chamber (when submerged in the bath). This approach had several shortcomings. Taping the samples inside the chamber/hot water bath was not ideal as it required the user to submerge their hand into the hot water to place and/or remove the samples. While heat-resistant gloves can be employed, these reduced the dexterity of the operator.

Others have also used an Anova immersion heater and a transparent food storage container to create a water bath for COVID-19 detection using reverse transcription polymerase chain reaction (RT-PCR). Arumugam et al., A rapid SARS-COV-2 RT-PCR assay for low resource settings, Diagnostics 10:739 (2020). In this design, the water bath setup was exposed to air and a Raspberry Pi-controlled servomotor was used to adjust and move the PCR tubes within the bath. The exposed design resulted in difficulties maintaining a constant temperature throughout the water bath and the servomotor added complexity with respect to submerging and extracting the samples, and ultimately viewing the results of the assays.

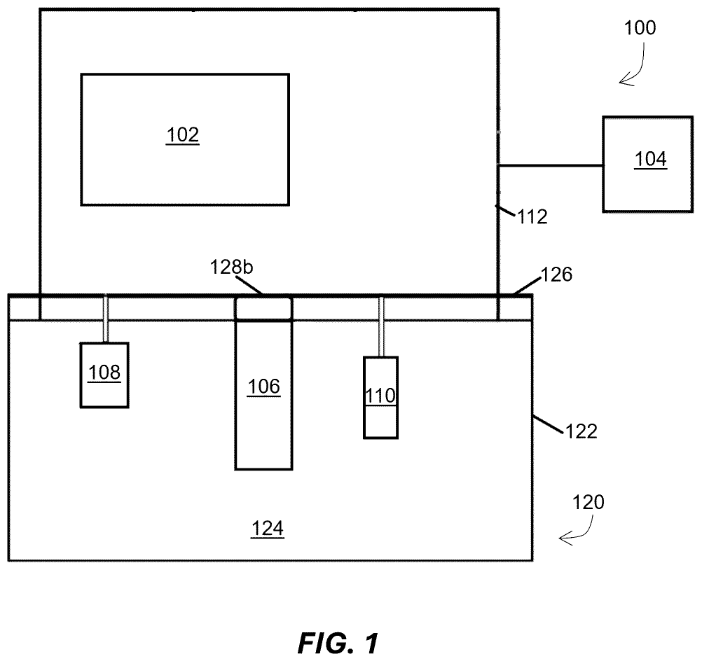

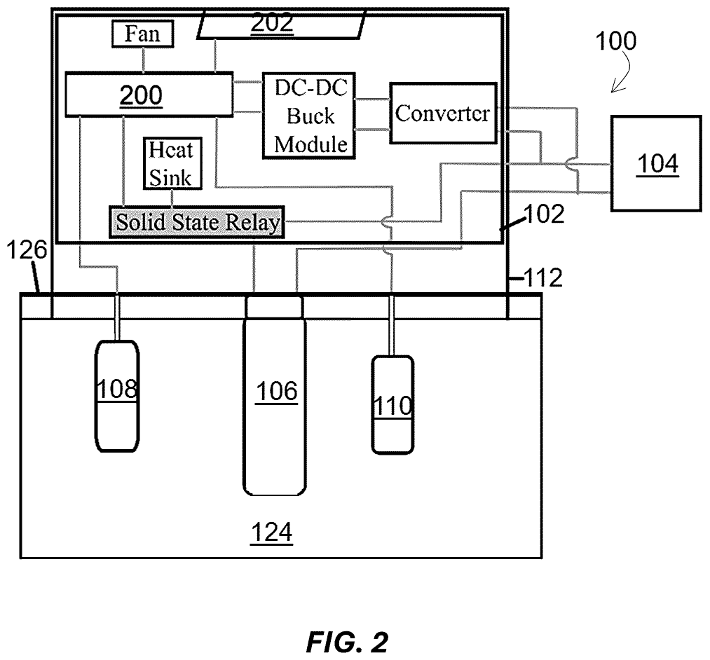

The present reaction systems for isothermal amplification overcome these issues. Now referring to FIG. 1, a reaction system 100 can comprise a sample loading unit 150 comprising a handle 152 coupled with a loading portion 155 (e.g., cartridge), a controller 102, a power supply 104, a heater 106, and a chamber 124. The controller 102 can be in electrical communication with at least the heater 106, and the power supply 104 can be coupled with the heater 106 and/or the controller 102. FIG. 2 shows additional detail regarding the electronic couplings that can be configured in the system 100.

The reaction system 100 enables isothermal amplification assays to be performed, wherein a fluid contained within the chamber 120 is heated and circulated around assay samples contained in the sample loading unit 150 and submerged in the heated fluid. The fluid can be water or another liquid. The fluid can be air. For example, the reaction system 100 can heat water (or air) in a chamber 120 to a temperature at or between about 55° C. to about 85° C. or more (such as, for example, 55° C. to about 85° C., about 55° C. to 85° C., 55° C. to 85° C., or greater than 85° C.) and circulate the fluid around the loading portion 155 comprising one or more assay samples. In certain embodiments, the reaction system 100 can heat fluid to a temperature at or between about 60°° C. to about 80° C. or more (such as, for example, 25° C. to about 80° C., about 25° C. to 80° C., 25° C. to 80° C., or greater than 80° C.). In certain embodiments, the reaction system 100 can heat fluid to a temperature at or between about 65° C. to about 75° C. or more (such as, for example, 30° C. to about 75° C., about 30° C. to 75° C., 30° C. to 75° C., or greater than 75° C.). In certain embodiments, the reaction system 100 can heat fluid to a temperature at or between about 35° C. to about 70° C. or more (such as, for example, 35° C. to about 70° C., about 35°° C. to 70° C., 35° C. to 70° C., or greater than 70° C.). In certain embodiments, the reaction system 100 can heat fluid to a temperature at or between about 40° C. to about 65° C. or more (such as, for example, 40° C. to about 65° C., about 40° C. to 65° C., 40° C. to 65° C., or greater than 65° C.). In certain embodiments, the reaction system 100 can heat fluid to a temperature at or between about 45° C. to about 60° C. or more (such as, for example, 45° C. to about 60° C., about 45° C. to 60° C., 45° C. to 60° C., or greater than 60° C.). In certain embodiments, the reaction system 100 can heat the fluid to a temperature at or between about 50° C. to about 55°° C. or more (such as, for example, 50° C. to about 55° C., about 50° C. to 55° C., 50° C. to 55°° C., or greater than 55° C.). The ranges described in this paragraph are inclusive of the stated end points and all 1° C. increments encompassed thereby.

The chamber 120 of the system 100 comprises a sealable reservoir comprising two or more outer walls 122 that define an interior 124 for holding a fluid therein, a top opening in communication with the interior 124, and a lid 126 configured to sealably seat over the top opening of the chamber 120. The fluid can be water, for example. The fluid can be air. The chamber 120 can be formed of any shape and of any suitable material, provided that the interior defines a sufficient volume to house a fluid that can be held at a consistent temperature and the sample loading unit 150. Furthermore, suitable materials will retain their integrity when heated to the temperatures described herein. In certain embodiments, the chamber 120 is rectangular. In certain embodiments, the chamber 120 is cylindrical. The chamber 120 can be any container capable of holding a liquid therein. In certain embodiments, the chamber 120 is formed by injection molding. The chamber 120 can define an interior 124 volume of at or about 1 quart to at or about 6 quarts (e.g., about 1 quart to 6 quarts, 1 quart to about 6 quarts, or 1-6 quarts). The chamber 120 can define an interior 124 volume of at or about 2 quarts to at or about 5 quarts (e.g., about 2 quarts to 5 quarts, 2 quarts to about 5 quarts, or 2-5 quarts). The chamber 120 can define an interior 124 volume of at or about 3 quarts to at or about 4quarts (e.g., about 3 quarts to 4 quarts, 3 quarts to about 4 quarts, or 3-4 quarts). The interior 124 volume can be less than about 1 quart. The chamber 120 can define an interior 124 volume of at or about 1 ounce to at or about 16 ounces (e.g., about 1 ounce to 16 ounces, 1 ounce to about 16 ounces, or 1-16 ounces). The chamber 120 can define an interior 124 volume of at or about 2 ounces to at or about 15 ounces (e.g., about 2 ounces to 15 ounces, 2 ounces to about 15 ounces, or 2-15 ounces). The chamber 120 can define an interior 124 volume of at or about 3 ounces to at or about 14 ounces (e.g., about 3 ounces to 14 ounces, 3 ounces to about 14 ounces, or 3-14 ounces). The chamber 120 can define an interior 124 volume of at or about 4 ounces to at or about 13 ounces (e.g., about 4 ounces to 13 ounces, 4 ounces to about 13 ounces, or 4-13 ounces). The chamber 120 can define an interior 124 volume of at or about 5 ounces to at or about 12 ounces (e.g., about 5 ounces to 12 ounces, 5 ounces to about 12 ounces, or 5-12 ounces). The chamber 120 can define an interior 124 volume of at or about 6 ounces to at or about 11 ounces (e.g., about 6 ounces to 11 ounces, 6 ounces to about 11 ounces, or 6-11 ounces). The chamber 120 can define an interior 124 volume of at or about 7 ounces to at or about 10 ounces (e.g., about 7 ounces to 10 ounces, 7 ounces to about 10 ounces, or 7-10 ounces). The chamber 120 can define an interior 124 volume of at or about 8 ounces to at or about 9 ounces (e.g., about 8 ounces to 9 ounces, 8 ounces to about 9 ounces, or 8-9 ounces). The chamber 120 can define an interior 124 volume of less than about 1 ounce. The ranges set forth in this paragraph are inclusive of the stated end points and all 0.5-ounce increments encompassed thereby.

In certain embodiments, at least one of the outer walls 122 comprises a transparent portion 123 such that the interior 124 can be viewed therethrough from outside of the chamber 120. The chamber 120 can comprise a wholly transparent container. The chamber 120 can comprise a container wherein all of the sidewalls comprise the transparent portion 123. In certain embodiments, the transparent portion 123 can span one sidewall of the chamber 120, two sidewalls of the chamber 120, three sidewalls of the chamber 120, or all sidewalls of the chamber 120. The degree of transparency of the transparent portion 123 can be wholly transparent (e.g., allowing full light passage therethrough) or varying degrees of optical translucency or clarity to the extent assay samples 10 positioned within the interior 124 of the chamber 120 are visible through the transparent portion 123 either by the naked eye or by an imaging device 160. The transparent portion 123 can be composed of any suitable material. In certain embodiments, the transparent portion 123 comprises glass, plexiglass, acrylic, polycarbonate, high-density polyethylene (HDPE), polypropylene, linear low-density polyethylene, or a low-density polyethylene. In certain embodiments, the transparent portion 123 comprises a clear acrylic sheet or material.

As noted above, the dimensions of the chamber 120 can comprise any dimensions suitable for housing a fluid within the interior 124 and the sample loading unit 150. In certain embodiments, the chamber 120 comprises a container having the following dimensions 12.8″ long×10.4″ wide×6″ tall. In certain embodiments, the chamber 120 comprises dimensions of 13″ long×13″ wide×8″ tall.

The lid 126 of the system 100 can be integrally formed with the outer walls 122, hingedly attached to or coupled with an outer wall 122 of the chamber, and/or the lid 126 can be removably attached to the top of the chamber 120. The lid 126 can be formed of the same or different material as the chamber 120 and, optionally, be coated with a waterproof or water-resistant solution.

In certain embodiments, the lid 126 (or a portion thereof) comprises a seal (not shown) such that, when positioned over the top opening of the chamber 120, the interior 124 of the chamber 120 (and any contents therein) are isolated from the exterior of the chamber 120. Alternatively, the seal can be positioned at or near the top opening of the chamber 120 such that, when the lid 126 is positioned over the top opening of the chamber 120 and the seal is engaged, the interior 124 of the chamber 120 (and any contents therein) are isolated from the exterior of the chamber 120. In either embodiment, a sealing relationship is formed between the lid 126 and the chamber 120 when the lid 126 is seated over the top opening of the chamber 120. For example, in use, the lid 126 can exert a compressive force on the top opening of the chamber 120 (or vice versa) such that a sealing relationship is formed therebetween. The seal can be substantially moisture-proof. The seal can be releasable such that the lid 126 can be applied and removed, repeatedly, to the top opening of the chamber 120. The seal can comprise a snap-on or press-fit seal, a screw-top seal, a gasket seal, a clamp or latch seal, a twist-lock seal, a cork or bung seal, a magnetic seal, or any other type of suitable seal now known or hereinafter developed. Many different types of seals are well-known in the art and can be applied in this context.

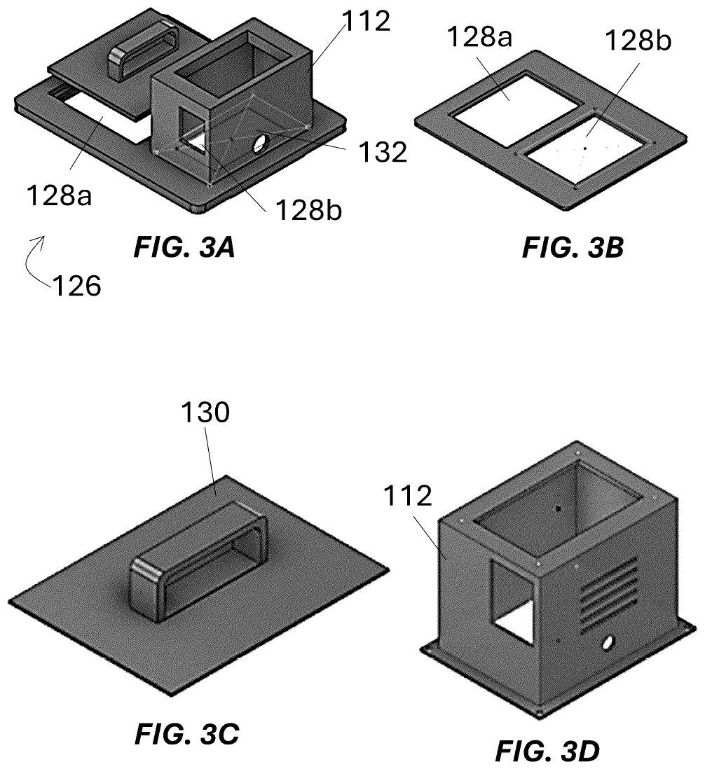

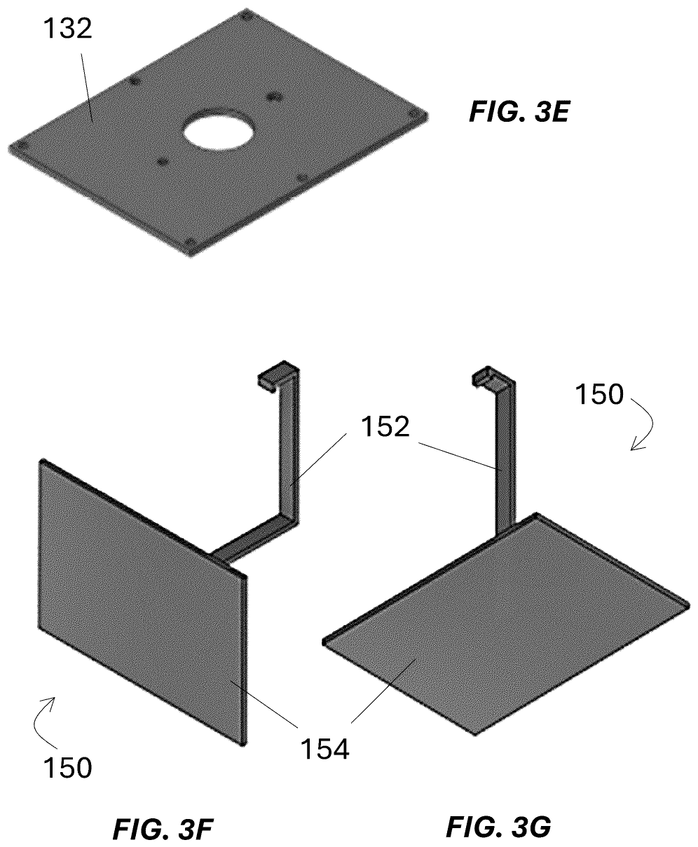

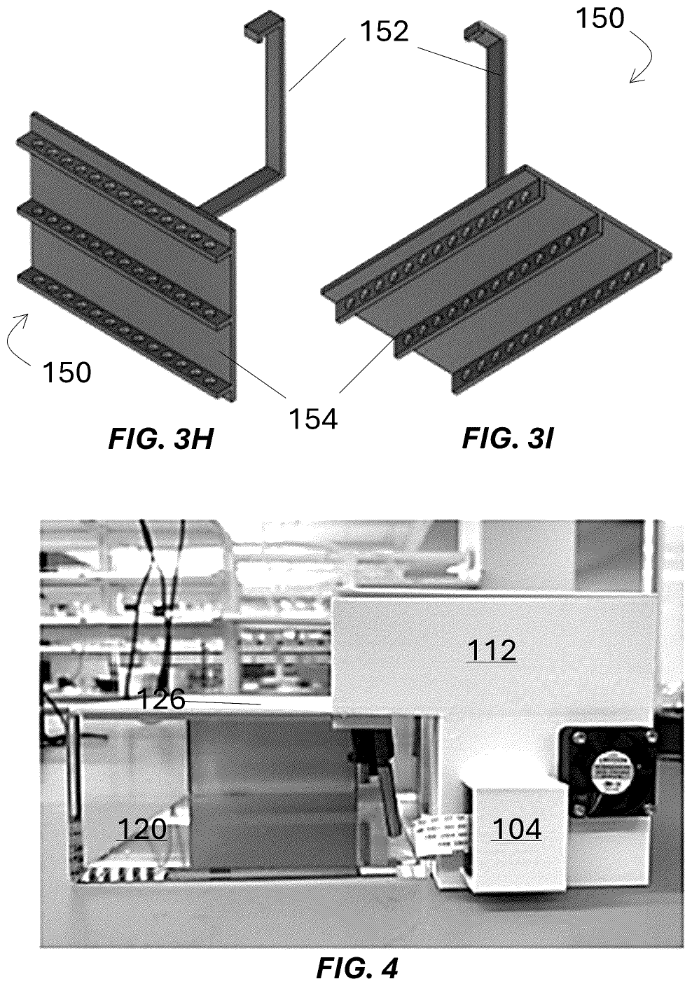

As shown in FIGS. 3A-3B, the lid 126 defines at least a first inlet 128a which is in communication with the interior 124 of the chamber 120 when the lid 126 is positioned over the top opening of the chamber 120. In certain embodiments, the lid 126 further defines a second inlet 128b that is also in communication with the interior 124 of the chamber 120 when the lid 126 is positioned over the top opening thereof. The lid 126 can define any number of inlets 128n as desired. The inlets 128a, 128b, 128n can comprise any size and/or configuration suitable.

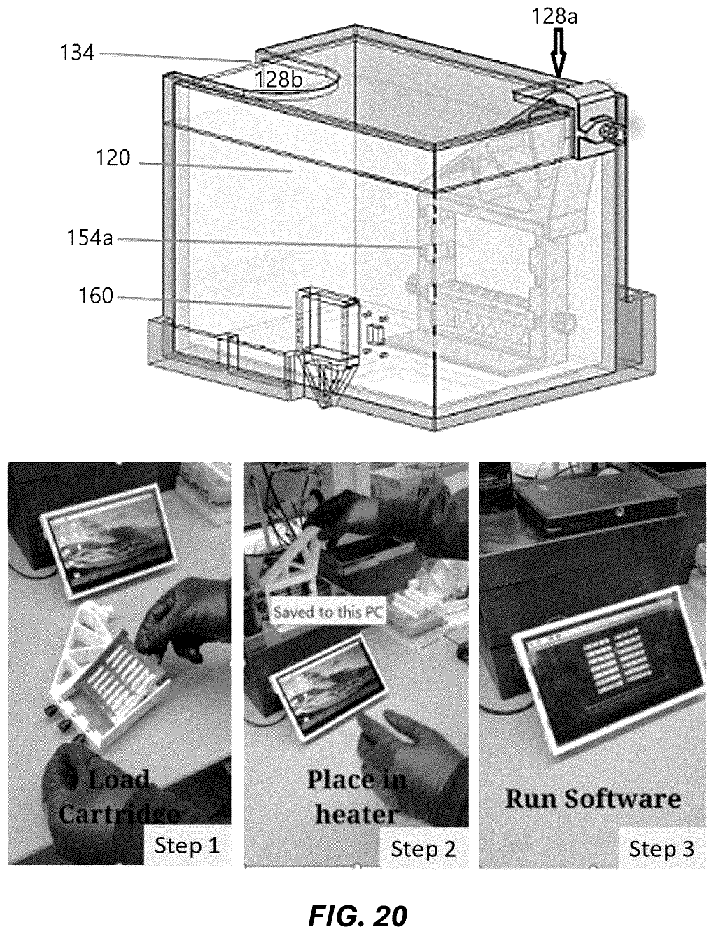

In certain embodiments, the first inlet 128a is configured to receive (e.g., slidably receive) a cartridge 154 of the sample loading unit 150 such that samples 10 positioned thereon or therein can be submerged in fluid contained within the interior 124 of the chamber without removing the lid 126 from the top opening of the chamber 120 (see, for example, FIGS. 3F-3I). The first inlet 128a can be configured such that the sample loading unit 150 can be anchored to an outer wall 122 of the chamber 120 and hang through the first inlet 128a (see, for example, FIG. 20). The cartridge 154 can comprise one or more sample holders 155, each sample holder 155 configured to receive, secure, and display an assay container or paper-strip assay therein. In certain embodiments, the cartridge 154 comprises leak-proof cartridge. In certain embodiments, the cartridge 154 defines a substantially waterproof or sealed environment in which the one or more sample holders 155 is housed. The cartridge can further comprise a transparent panel such that any samples 10 positioned within the sample holders 155 are visible therethrough. The substantially transparent panel can be composed of glass, acrylic, plastic, plexiglass, polycarbonate, HDPE, polypropylene, linear low-density polyethylene, a low-density polyethylene, or any other suitable material that is inert upon heating to the temperatures contemplated herein. The cartridge 154 can comprise a frame 154a, for example an acrylic frame fabricated using a carbon dioxide laser cutter. The frame 154a can be configured to receive one or more sample holders 155 therein (see, e.g., FIG. 20).

The second inlet 128b can be configured to receive at least a portion of the heater 106 therethrough (e.g., where the heater 106 is an immersion heater) such that the heater 106 can directly interact with fluid housed within the interior 124 thereof. In certain embodiments, the second inlet 128b can additionally or alternatively receive a temperature sensor 108 therethrough and/or a circulator 110 for circulating the fluid within the interior 124 of the chamber 120 to facilitate maintenance of a uniform temperature throughout the fluid.

The lid 126, in certain embodiments, further defines an area 132 for supporting the controller 102 of the system 100 and/or the heater 106. In certain embodiments, the lid 126 further comprises a housing 112 arranged substantially over the area 132 (FIGS. 2 and 3D). The area 132 can be, for example, a plate (i.e., a metal plate). The area 132 can define a hanging slot 134 configured to receive at least a portion of the heater 106 therethrough that is covered and/or protected by the housing 112.

The housing 112 can be integrally formed with the base of the lid 126 and/or the area 132 and comprise any suitable materials. The housing 112 can be dustproof, shockproof, or otherwise protected from damage from impact or foreign substance. In certain embodiments, the housing 112 is formed from acrylonitrile butadiene styrene (ABS) filament by a three-dimensional (3D) printer using high temperature resin V2. The housing 112 can be a polymer housing, such as injected molded polyethylene terephthalate (PET) or HDPE. Alternatively, the housing 112 can be metal, such as stainless steel or cast aluminum. The housing 112 can be formed of any other suitable material.

The hanging slot 134 can be aligned with the second inlet 128b such that at least a portion of the heater 106 can be inserted through the hanging slot 134 and second inlet 128b and into the interior 124 of the chamber 120 for submersion into any fluid contained therein, while the electronics required to operate the heater 106 and/or the controller 102, such as moisture-sensitive relays, drivers, electronics, etc. that generate heat themselves can be arranged within the housing 112 of the lid 126 in a location outside of the chamber 120/away from the interior 124 and any fluid housed therein. This not only removes heat-producing components from within the interior 124 (other than the portion of the heater 106 for producing heat), thus allowing for the more precise heating of the fluid contained within the interior 124, but also protects the core electrical components within the housing 112, including without limitation, the controller 102 and accessories thereof such as a fan, display 202, converter, solid state relay, heat sink, etc.

The heater 106 can comprise any heater or heating element that can heat the fluid contained in the interior 124 of the chamber 120. In certain embodiments, the heater 106 is an immersion heater such as a 1650W-120V immersion heater (e.g., where the fluid is water). In certain embodiments, the heater 106 is a flanged immersion heater, a screw plug immersion heater (e.g., where the hanging slot 124 is threaded, such that the heater 106 can be screwed thereto), a circulation heater (wherein a separate circulator 110 is not required), an electric water heater, a tubular heater configured for immersion, or an open coil heater.

The heater 106 can, in certain embodiments, comprise a heat sink and heating element housed within a water-resistant housing that generally functions to communicate heat from the heating element into the fluid by establishing a relatively low thermal resistance (e.g., relatively high surface area, relatively high thermal conductivity) heat path between the heating element and fluid within the interior 124. In certain embodiments, the heatsink can comprise elongated fins spaced substantially evenly around the heating element, both of which are centered within a cylindrical, water-resistant housing. In other embodiments, the heater 106 comprises multiple heating elements, each arranged on a wall that defines a cavity within a water-resistant housing.

The heater 106 can alternatively comprise a solid-state heater such as, for example, an indium tin oxide (ITO)-coated glass heater. In such embodiments, the fluid can be water, another liquid medium, or air. The heater 106 can perform heat transfer to the cartridge 154 positioned within the interior 124 (and thus any assay samples 10 housed therein) through conduction or convection, for example.

In certain embodiments, the heater 106 can further comprise a light source for illuminating the interior 124 of the chamber 120 to facilitate visibility and/or clarity of any assay samples 10 positioned therein (e.g., in the sample loading unit 150).

The reaction system 100 can further comprise one or more accessory components, such as a one or more temperature sensors 108 and/or a circulator 110, each of which can be inserted through the hanging slot 134 and second inlet 128b, and at least partially immersed within fluid contained within the chamber 120. Furthermore, the reaction system 100 can further comprise a light source 175 in communication with the controller 102 that backlights or otherwise illuminates the interior 124 of the chamber 120 to facilitate visibility of any assay samples 10 positioned therein (e.g., in the sample loading unit 150).

The temperature sensor 108 generally functions to measure a temperature of fluid within the chamber 120. The temperature sensor 108 can be arranged within the interior 124 adjacent to or at a distance from the heater 106, adjacent to a cartridge 154 inserted through the first inlet 128a, or adjacent to an outer wall 122 of the chamber 120. In certain embodiments, the temperature sensor 108 is arranged on an exterior surface of an outer wall 122 of the chamber 120. Alternatively, the temperature sensor 108 can be arranged in any other location on or within the chamber 120.

In certain embodiments, the reaction system 100 further comprises more than one temperature sensor 108. In this embodiment, the temperature sensors 108 can be spaced apart by some distance such that the controller 102 can analyze temperature readings from each temperature sensor 108 to estimate the rate of heat transfer into the fluid (based on a known volume of the interior 124, for example) and/or to determine if a temperature gradient exists in a portion of fluid within the chamber 120. In this manner, the controller 102 can calibrate the temperature sensors 108 by comparing temperature readings from both prior to powering the heater 106 (i.e., when the temperature of fluid in the chamber 120 is substantially even throughout) and then adjusting a sensor-signal-to-temperature conversion algorithm for each temperature sensor 108 such that the temperature readings for the temperature sensors 108 substantially match prior to heating the fluid. This can reduce measurement errors due to manufacturing inconsistencies in components incorporated in signal conditioning circuits for the temperature sensors 108.

The temperature sensor 108 can include a thermistor. The temperature sensor 108 can comprise a resistance thermometer, a quartz thermometer, a silicon bandgap temperature sensor, or any other suitable type of temperature sensor or temperature sensing element.

The circulator 110 of the reaction system 100 is configured to move fluid throughout the interior 124 of the chamber 120 and, for example, around the heater 106. Generally, the circulator 110 functions to circulate fluid in the chamber 120 along or around the heater 106 to distribute heat substantially evenly throughout the fluid in the chamber 120. The circulator 110 can comprise a submergible rotary motor, a submergible rotary electric motor, or any other immersion motor suitable for immersion in fluid contained within the interior 124 of the chamber 120 (e.g., where the fluid comprises a liquid). In certain embodiments, the circulator 110 is a fan (e.g., where the fluid is air).

In certain embodiments, the circulator 110 is a submergible rotary electric motor that is an AC motor powered by an alternating (AC) electric current controlled vi an analog relay or solid-state relay controlled by the controller 102 to regulate power distribution to the circulator 110 (e.g., from the power supply 104). Alternatively, the circulator 110 can be a DC motor powered by a direct (DC) electric current, also controlled via an analog relay or solid-state relay (e.g., MOSFET, H-bridge, or BJT). In certain embodiments, the system 100 further comprises a rectifier and voltage regulator that converts AC from a standard residential 120 VAC power supply 104 into 12 VDC to power the circulator 110 and other components of the system 100 (such as, for example, the controller 102, heater 106, etc.). In certain embodiments, the system 100 further comprises a power adaptor for a power supply 104 into a DC signal (e.g., 12 VDC) to power the circulator 110 and other components of the system 100 such that an alternating current signal remains substantially removed from the system 100 and any fluid within the chamber 120. However, the circulator 110 can be any other suitable type of motor powered and controlled in any other suitable way.

The circulator 110 can be arranged within the interior 124 of the chamber 120. In certain embodiments, the circulator 110 is arranged adjacent or proximate to the heater 106. In certain embodiments, the circulator 110 is rigidly mounted to an interior of an outer wall 122 of the chamber 120. In certain embodiments, the circulator 110 is supported by the area 132 and suspended through at least a portion of the hanging slot 134.

In certain embodiments, the circulator 110 includes linearly-or rotationally-driven paddles, fans, vanes, or the like powered by an electric, pneumatic, hydraulic, or other suitable type of motor or actuator. However, the circulator 110 can include any other component of any other type and arranged in any other way within the chamber 120. Alternatively, the system 100 can exclude the circulator 110 and instead rely on convection or other modalities to induce fluid flow along the heater 106 as thermal energy is conducted into fluid within the interior 124.

The controller 102 performs the role of managing and controlling the behavior of the heater 106, circulator 110, and any other electrical components of the system 100. For example, the controller 102 can be in electrical communication with at least the heater 106 and/or the circulator 110 and be configured to control the heater 106 and the circulator 110 according to a temperature of the fluid measured by the temperature sensor 108, thereby maintaining the fluid at a target temperature for a predetermined period of time. In certain embodiments, the controller 102 comprises a closed-loop control system, which can maintain a desired set target temperature of fluid within the chamber 120 based on feedback obtained (or given) by the temperature sensor(s) 108. Accordingly, the controller 102 can be configured to receive, from the temperature sensor(s) 108, data comprising current temperature of the fluid in the chamber 120, and send signals to the solid-state relay to allow or block the flow of current to the heater 106 based on the current temperature reading and the set target temperature. Through this process, the reaction system 100 can reach a set target temperature and maintain it for a predetermined (or indefinite) period of time.

The controller 102 can be a processor, integrated circuit, or other electrical circuitry, and, as described above, can be arranged within the housing 112 of the lid 126 where it can be protected from fluid that could be damaging.

The controller 102 can be any type of controller capable of controlling and managing the behavior of the other components of the system 100. The controller 102 can comprise a processor (e.g., microprocessor), microcontroller 200, integrated circuit, or other analog or digital circuitry configured to receive a parameter (e.g., desired temperature selection), and a temperature-dependent signal from the temperature sensor(s) 108, and to output signals to control the heater 106, circulator 110 (where applicable), display 202 and/or input region 204. In certain embodiments, the controller 102 outputs a first low-current signal (e.g., a digital signal, a digital pulse-width modulated signal) to a first relay to control a high-current power signal to the circulator 110 and a second low-current signal to a second relay to control a high-current power signal to the heater 106. In embodiments wherein the controller 102 comprises a display 202, the controller 102 can also output one or more signals to a display driver that controls the output of the display 202. The controller 102 can be further coupled with a multiplexer that combines outputs from various sensors of the input region 204, such as each of a set of position sensors or electrodes of a capacitive touch display, into a single digital signal. Notwithstanding the examples set forth herein, it will be understood that the controller 102 can handle inputs (e.g., from the temperature sensor(s) 108) and outputs (e.g., a control signal for the heater 106) in any other suitable way.

In certain embodiments, the controller 102 can be electronically coupled with one or more of a fan, non-transitory memory, an input region 204, a display 202, a DC-DC buck module, an AC-DC converter, a solid-state relay, a heat sink, and/or a power supply 104. The controller 102 can comprise a Raspberry Pi 1, 2, 3, 3B+ or other various other motherboards and processors manufactured by conventional microprocessor suppliers such as Intel Corporation of Santa Clara, California and Advanced Micro Devices (AMD) of Sunnyvale, California. Optional components of such microprocessors include WiFi connectivity, cellular wireless connectivity, Ethernet connectivity, and other connectivity options that will be known to those skilled in the art. Data storage options may comprise non-volatile memory devices such as flash storage, hard disks, external flash sockets, and can additionally provide connectivity for various I/O devices, including monitors, video displays, audio output and the like.

The controller 102 can comprise a display 202 and/or an input region 204. The display 202 can be arranged on the housing 112, for example, an external surface of the housing 112 and/or coupled therewith. In certain embodiments, the display 202 and/or input region 204 can be removeably coupled with the housing 112.

Generally, the display 202 functions to display a user input (e.g., in conjunction with a parameter of the assay or temperature selection entered into the input region 204) and/or assay parameter. In certain embodiments, the display 202 comprises a backlit liquid crystal display (LCD). The display 202 can be a light-emitting diode (LED) segment display, an e-ink display, a plasma display, a set of labeled lamps (e.g., LEDs) or any other suitable type of color, black and white, segment, or dummy light display arranged in any other location on or within the housing 112.

The input region 204 can be arranged on an external surface of the housing 112 and/or coupled therewith and be configured to receive a target temperature parameter. Generally, the input region 204 functions to receive a user input pertaining to at least one of a desired target temperature for the fluid, a desired time (e.g., the length of time required for the assay), and/or other desired parameters. The target temperature or other parameters captured by the input region 204 can then be implemented by the controller 102 to set the assay temperature, the total length of time of the assay, the test start time, the test end time, etc. and/or to select a target temperature and assay time based on the type of assay, volume of assay tests (e.g., where the assay comprises a liquid assay), etc. In certain embodiments, the input region 204 comprises an LCD pad, a keypad or keyboard, a knob (e.g., comprising a position sensor linked to a microprocessor of the controller 102), a mouse, a touchscreen, or the like.

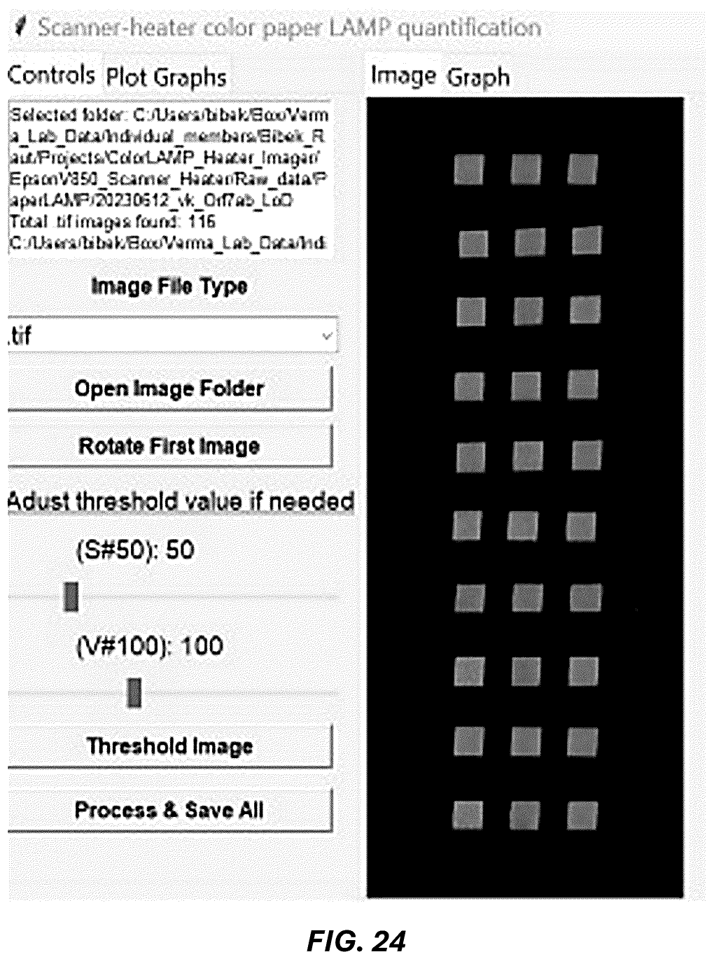

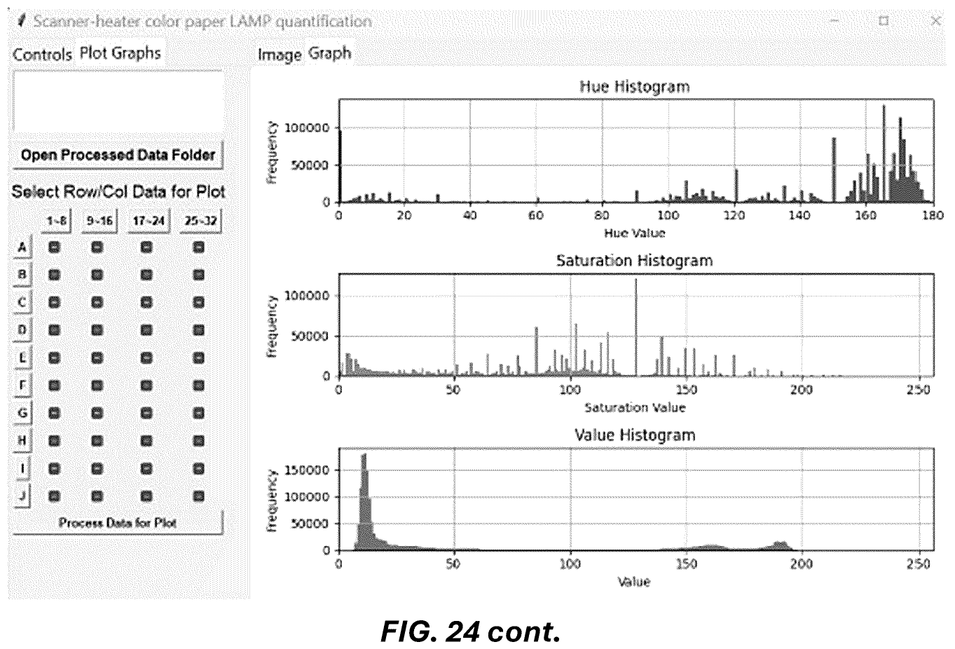

In certain embodiments, the display 202 and the input region 204 are cooperatively embodied in a touch display, wherein a touch sensor (e.g., a capacitive touch sensor) within the touch display defines the input region 204 and the display of the touch display defines the display 202. In certain embodiments, the display 202 can cycle through current temperature, set temperature, and other parameters (e.g., desired assay start time, desired assay end time, etc.) in response to a user selection of a current parameter rendered on the display 202. In certain embodiments, the display 202 can display a target temperature and a current temperature concurrently. In certain embodiments, the display 202 can alternatively switch between rendering the current fluid temperature, the remaining assay time, and/or other assay parameters, such as every five seconds or in response to an input in the input region 204 (e.g., rotation of a knob). It will be appreciated that the display 202 can render any suitable or parameter-related information in any other way as desired. Accordingly, the input region 204 and display 202 can therefore cooperate to enable a user to navigate through menus, enter and set temperature and assay parameters, and/or review parameters while the reaction system 100 is in use. The display 202 and/or input region 204 display the graphical user interface shown in FIG. 24.

The controller 102 further functions to set temperature and/or assay parameters of the reaction system 100. As described above, the controller 102 can select a run time and target temperature based on the assay to be performed using the chamber 120. In certain embodiments, the controller 102 implements static temperature and time settings to set the assay run time and temperature based on parameters entered by a user (e.g., using the input region 202) or as otherwise set with the controller 102. The controller 102 can therefore implement a memory module or any other suitable form of data storage to store one or more of the parameter settings. The controller 102 can, in certain embodiments, also communicate wirelessly (e.g., via Bluetooth, WiFi, or cellular connection) with an external electronic device (e.g., a smartphone, tablet, or computer) to download assay parameters.

The reaction system 100 further comprises a power supply 104 configured to run the electronic components (e.g., the controller 102 and related accessories) and the heater 106, and/or the circulator 110. The power supply 104 can, in certain embodiments, be positioned within a second housing integral or coupled with the lid 126 or an exterior surface of the chamber 120 (see, e.g., FIG. 4). In certain embodiments, the power supply 104 is a single power source.

The power supply 104 can be a battery. In certain embodiments, the power supply 104 is a wall power adaptor for providing power signals to high-power components of the system 100, such as the heater 106 and/or circulator 110. The power supply 104 can include one or more of a rectifier, voltage regulator, and/or one or more relays. In certain embodiments, the rectifier and voltage regular can cooperate as is known in the art to communicate a lower-power signal to the controller 102 and/or the temperature sensor(s) 108, while the relays (controlled by low-powered signals from the controller 102) control communication of high-power signals to the heater 106 and/or circulator 110.

Alternatively, the power supply 104 can communicate a DC power signal to the controller 102 and/or the temperature sensor(s) 108, and the controller 102 can control a relay to control an AC power signal to the heater 106.

The power supply 104 can be a 120V AC power outlet. There, in certain embodiments, the reaction system 100 can further comprise an AC-DC converter and a DC-DC buck module (or the like) connected in series to convert the 120V AC supply to 6V DC and supply power to the controller 102, wherein all other components of the system 100 are then powered by the controller 102.

In certain embodiments, the power supply 104 further comprises a back-up power supply coupled with at least the controller 102. The back-up power supply can comprise a battery. In certain embodiments, the battery is a lithium polymer battery.

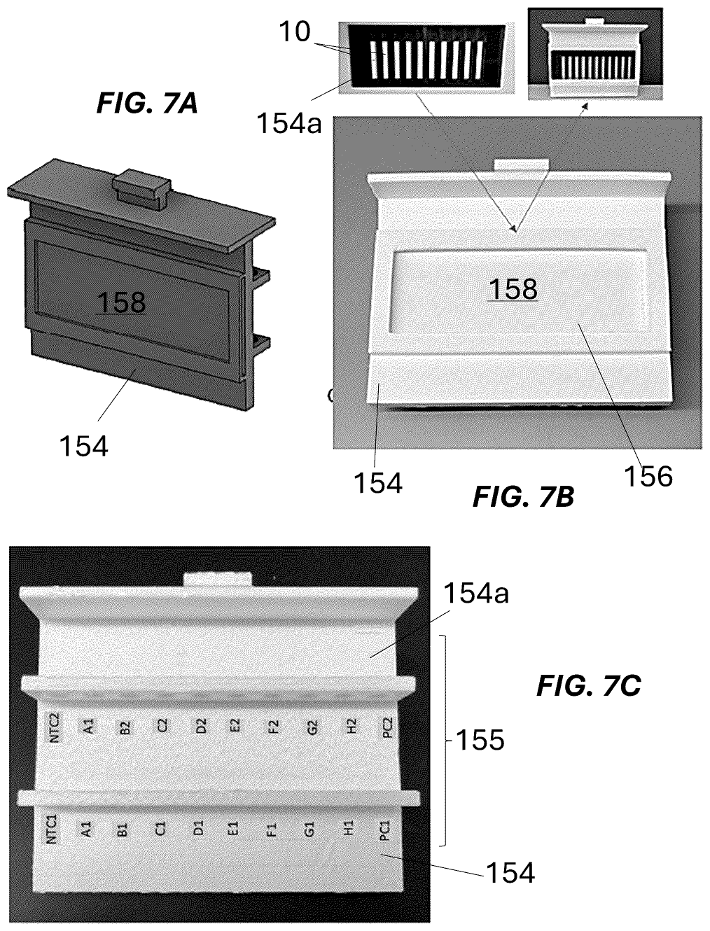

The reaction system 100 further comprises a sample loading unit 150 (FIGS. 3F-3I and 7A-7C). The sample loading unit 150 comprises a handle 152 and a cartridge 154. At least the cartridge 154 of the unit 150 is sized and shaped to be inserted through the first inlet 128a into the interior 124 such that samples 10 positioned within the cartridge 154 can be heated by fluid contained within the interior 124 of the chamber 120.

The cartridge 154 of the sample loading unit 150 comprises a waterproof or water-resistant or otherwise sealed cartridge chamber 156 comprising one or more sample holders 155. Each sample holder 155 can be configured to receive, secure, and display an assay container or strip therein. In certain embodiments, the sample holder 155 is configured to receive, secure, and display a strip assay 10 (e.g., a paper strip) (FIG. 7B). For example, and without limitation, a sample holder 155 can comprise a piece of polymerase chain reaction (PCR) tape or lidding film for securing a paper strip sample in place on a frame 154a of the cartridge 154. In certain embodiments, the sample holder 155 is configured to receive, secure and display a tube or other liquid-assay container (e.g., a plastic tube) (FIG. 7C). For example, and without limitation, a sample holder 155 can comprise a series of holes each configured to receive and retain a tube therethrough. Each sample holder can be numbered for assay identification purposes (FIG. 7C).

The chamber 156 of the cartridge 154 is configured to open such that one or more assay samples 10 can be positioned in the sample holder(s) 155, and also to close to seal the secured assay samples 10 positioned thereon within the chamber 156. In certain embodiments, the chamber 156 is waterproof or watertight such that, when the cartridge 154 is submerged or positioned within fluid in the chamber 120, the assay samples 10 remain dry and/or are not otherwise exposed to the fluid in the interior 124 of the chamber 120. The chamber 120 further comprises at least a transparent front wall 158 such that the samples are clearly visible therethrough when secured within the sample holders 155. The transparent front wall 158 can be composed of the same material as the portion of the two or more outer walls of the chamber 156 that is transparent.

The handle 152 can be integral with or coupled with the cartridge 154 and is configured to facilitate manipulation of the cartridge 154 (e.g., via the first inlet 128a) into and out of fluid contained with the interior 124 of the chamber 120 without the user being required to touch the fluid. The handle 152 can be sized and shaped to extend through the first inlet 128a and, optionally, to prevent the distal end of the handle 152 (relative to the cartridge 154) from submerging in the fluid within the chamber 120.

In operation, when samples are positioned in the cartridge 154, the chamber 156 is securely closed, and the cartridge 154 is positioned within the interior 124 of the chamber 120, the thermal energy from the fluid (e.g., the heat) is transferred into the chamber and, thus, the samples contained therein. In this manner, the samples can be heated consistently to the target temperature of the fluid (e.g., set by the user using the controller 102) for a period of time required to run the assay. Furthermore, due to the alignment of the transparent front wall 158 of the cartridge 154 and the transparent portion of the outer walls 122 of the chamber 120, a user or an imaging device 160 can visualize any colorimetric results of the assay samples. In this manner, the reaction system 100 can be used to detect pathogens or other target nucleic acid sequences (e.g., where the assays show positive visible results) at point-of-care for human applications, on farms for plant and animal applications, and in production facilities for food safety applications.

In reaction system 100 can further comprise an imaging device 160 positioned to capture images (e.g., through the transparent portion 123 of an outer wall portion of the chamber 120) of the one or more sample holders 155 positioned within the interior 124. The imaging device 160 can be a camera. The imaging device 160 can be a scanner. In certain embodiments, the imaging device 160 is coupled with and/or in electrical communication with the controller 102. The imaging device 160 can be operated, for example by a program executed by the controller 102, to take timelapse images of the sample holders 155 over a period of time (e.g., in 1 minute or 1 second intervals). The imaging device 160 can be operated to, for example, by a program executed by the controller 102, to send captured images to the controller 102 for storage in a memory module thereof, for processing by the controller 102, and/or for display on the display 202.

The reaction system 100 can further comprise a light source 175, for example, a backlight, positioned to illuminate the interior 124 of the chamber 120 and/or to illuminate the one or more sample holders 155. The light source 175 can assist with imaging clarity, for example, when an image is taken of the samples 10 by the imaging device 160. In certain embodiments, the brightness of the light source 175 can be adjusted to optimize contrast in the results (i.e., in the images taken of the samples 10).

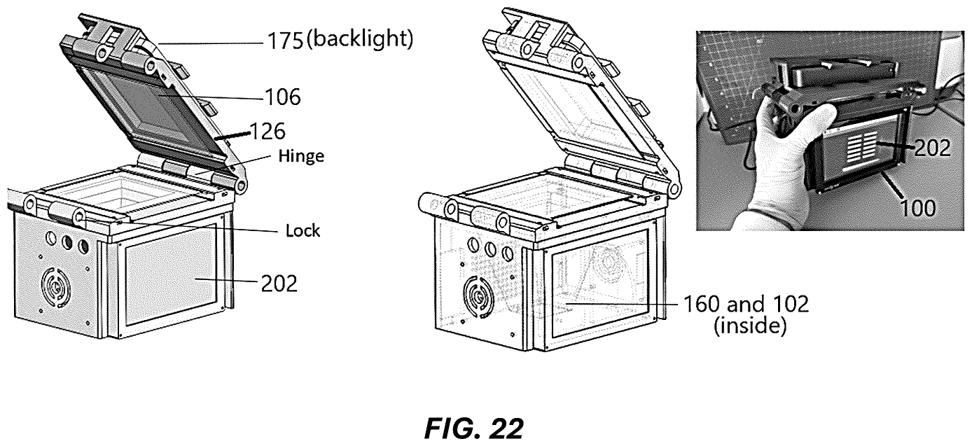

FIG. 22 shows at least one embodiment of a reaction system 100 wherein the heater 106 comprises an ITO-coated glass heater, the imaging device 160 and controller 102 components are positioned within the interior 124 of the chamber 120, and the system 100 further comprises a light source 175 comprising a backlight positioned opposite the imaging device 160 such that, in use, samples 10 positioned to be tracked by the imaging device 160 are illuminated thereby. In this embodiment, the fluid comprises air and the heater 106 is positioned to heat samples positioned within a cartridge 154. Accordingly, the heater 106 need not be positioned within the interior 124 of the chamber 120. Further, the reaction system 100 comprises a display 202 (that can also comprise an input region 204).

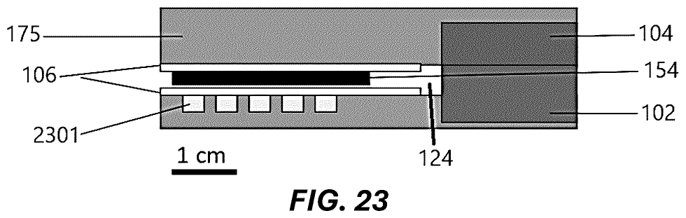

Now referring to FIG. 23, in certain embodiments of the reaction system 100, the heater 106 comprises an ITO-coated glass heater positioned on two sides of the interior 124 of the chamber 120. Accordingly, a space is defined therebetween for placement of the cartridge 154 of the sample loading unit 150 in operation. Furthermore, the reaction system 100 can comprise a light source 175 positioned on one side of the chamber 120, for example comprising a white LED for back illumination of samples 10 loaded within the cartridge 154. The power supply 104 of the system 100 can comprise, for example, one or more batteries. In certain embodiments, the power supply 104 comprises a rechargeable LiPo battery. The controller 102 (and electrical components thereof) are positioned adjacent to the power supply 104 in a location separate from the heater 106.

In certain embodiments, the reaction system 100 can further comprise a photodiode color sensor 2301 for measuring color changes during the assay reactions in the samples 10 positioned within the sample holders 155 in real-time. The photodiode color sensor 2301 can be in communication with the controller 102.

The reaction systems 100 provide a sealed container (i.e., the chamber 120) for uniform heating; and 2) an easy-to-use sample loading unit 150 for hanging samples 10. These features provide clear benefits over conventionally available water baths, and also allow for heating the fluid in the interior 124 of the chamber 120 quickly and maintaining it at a consistent temperature for the desired period of time. Table 1 is a comparison of a reaction system 100 hereof to conventional devices.

TABLE 1
Comparison among different heating devices

| | | | | Precision ™ |
|---|---|---|---|---|
| | | | | General |
| | | Anova Culinary | CORIO ™ Open | Purpose |
| | | AN500-US00 Sous | Heating Bath | Baths |
| | | Vide Precision | Circulator | TSGP02 |
| | IsoHeat | Cooker (ANOVA, | 1181J97 | (Fisher, |
| | (current work) | 2023) | (Scientific, 2023) | 2023) |
| Transparency | Transparent | Depends on the | Transparent | Not |
| of water | | water container | | transparent |
| chamber | | being used | | |
| Heating | Closed heating^{a} | Open heating^{b} | Open heating^{b} | Closed |
| system | | | | heating^{a} |
| Capacity | Water capacity | Variable capacity | Water capacity is | Water |
| | is 6 L | depending on the | 5 L | capacity is |
| | | container size | | 2 L |
| Cost | Development | Heating device cost | Device costs | Device costs |
| | cost of the water | $XXX, additional | $2272.08 | $1050 |
| | bath is around | costing required for | | |
| | $XXX, | container and extra | | |
| | additional $XX | parts | | |
| | required for the | | | |
| | Sample holding | | | |
| | accessories | | | |

^{a}Closed heating systems cannot exchange any matter (i.e., vapor)
^{b}Open heating systems can exchange matter

Methods for performing an isothermal amplification assay using the devices and systems 100 hereof are also provided. The methods hereof can be performed using any of the reaction systems 100 described herein.

In certain embodiments, the method comprises activating the heater 106 to heat fluid within the interior 124 of the chamber 120 to a target temperature. Activating the heater 106 can be initiated by a user via the controller 102 (e.g., using the display 202 and/or input region 204 thereof). The fluid can be water or air. The fluid can be any suitable liquid. In certain embodiments, the chamber 120 and/or interior 124 need not be entirely sealed (e.g., only partially sealed) or need not be air tight.

The target temperature can be any desired temperature. The target temperature can be at or about 37-85° C., for example. The target temperature can be at or about 38-84° C. (such as 38° C. to about 84° C., about 38° C. to 84° C., or 38° C. to 84° C.). The target temperature can be at or about 39-83° C. (such as 39° C. to about 83° C., about 39° C. to 83° C., or 39° C. to 83° C.). The target temperature can be at or about 40-82° C. (such as 40° C. to about 82° C., about 40° C. to 82° C., or 40° C. to 82° C.). The target temperature can be at or about 41-81° C. (such as 41° C. to about 81° C., about 41° C. to 81° C., or 41° C. to 81° C.). The target temperature can be at or about 42-80° C. (such as 42° C. to about 80° C., about 42°° C. to 80° C., or 42° C. to 80° C.). The target temperature can be at or about 43-79° C. (such as 43° C. to about 79° C., about 43° C. to 79° C., or 43° C. to 79° C.). The target temperature can be at or about 44-78° C. (such as 44° C. to about 78° C., about 44° C. to 78° C., or 44° C. to 78° C.). The target temperature can be at or about 45-77° C. (such as 45° C. to about 77° C., about 45° C. to 77° C., or 45° C. to 77° C.). The target temperature can be at or about 46-76°° C. (such as 46° C. to about 76° C., about 46° C. to 76° C., or 46°° C. to 76° C.). The target temperature can be at or about 47-75° C. (such as 47° C. to about 75° C., about 47°° C. to 75° C., or 47° C. to 75° C.). The target temperature can be at or about 48-74° C. (such as 48° C. to about 74° C., about 48° C. to 74° C., or 48° C. to 74° C.). The target temperature can be at or about 49-73° C. (such as 49° C. to about 73° C., about 49° C. to 73° C., or 49° C. to 73° C.). The target temperature can be at or about 50-72° C. (such as 50° C. to about 72° C., about 50° C. to 72° C., or 50° C. to 72° C.). The target temperature can be at or about 51-71° C. (such as 51° C. to about 71° C., about 51° C. to 71° C., or 51° C. to 71° C.). The target temperature can be at or about 52-70° C. (such as 52° C. to about 70°° C., about 52° C. to 70° C., or 52° C. to 70° C.). The target temperature can be at or about 53-69° C. (such as 53° C. to about 69° C., about 53° C. to 69° C., or 53° C. to 69° C.). The target temperature can be at or about 53-68° C. (such as 53° C. to about 68° C., about 53° C. to 68° C., or 53° C. to 68° C.). The target temperature can be at or about 54-67° C. (such as 54° C. to about 67° C., about 54° C. to 67° C., or 4° C. to 67° C.). The target temperature can be at or about 55-66° C. (such as 55° C. to about 66° C., about 55° C. to 66° C., or 55° C. to 66° C.). The target temperature can be at or about 56-65° C. (such as 56° C. to about 65° C., about 56° C. to 65° C., or 56° C. to 65° C.). The target temperature can be at or about 57-64° C. (such as 57° C. to about 64° C., about 57° C. to 64° C., or 57° C. to 64° C.). The target temperature can be at or about 58-63° C. (such as 58° C. to about 63° C., about 58° C. to 63° C., or 58° C. to 63°° C.). The target temperature can be at or about 59-62° C. (such as 59° C. to about 62° C., about 59° C. to 62° C., or 59° C. to 62° C.). The target temperature can be at or about 60-61° C. (such as 60° C. to about 61° C., about 60° C. to 61° C., or 60° C. to 61° C.). The ranges stated in this paragraph are inclusive of the stated end points and all 0.5° C. increments included therein.

In certain embodiments, the target temperature can be obtained within about 12 minutes from activating the heater 106 of the system 100. In certain embodiments, the target temperature can be obtained within about 15 minutes from activating the heater 106. In certain embodiments, the target temperature can be obtained within about 10-15 minutes from activating the heater 106. In certain embodiments, the target temperature can be obtained within about 20 minutes from activating the heater 106.

Before, after, or during the heating step, a cartridge 154 of the sample loading unit 150 can be inserted into the interior 124 of the chamber 120 and fluid contained therein. The cartridge 154 can comprise one or more isothermal assay samples 10 to be run. As described in detail above, the cartridge can secure one or more paper-based or tube isothermal assay samples 10 therein and display such samples 10 through the transparent front wall 158. While paper-strip and tube-based assays are described herein, it will be appreciated that any other isothermal assay samples 10 can be employed where visible results can be obtained.

The method can further comprise inserting one or more samples 10 into the cartridge 154 of the sample loading unit 150 and, optionally, securing the samples 10 thereto. In certain embodiments, the samples 10 are inserted into the sample loading unit 150 such that the assays thereof are visible through the transparent front wall 158. In this manner, a user can visibly assess the reaction of an assay positioned within the cartridge. The samples 10 can be taped to the frame 154a of the cartridge 154. The samples 10 can be positioned within holders 155 specifically designed to receive and retain the samples 10. Where the cartridge 154 comprises a leak-proof cartridge, the samples 10 can be sealed within the substantially waterproof or sealed environment thereof prior to positioning the cartridge 154 within the interior 124 of the chamber 120. The sample loading unit 150 can optionally be secured to the chamber 120 (e.g., secured and tightened against an outer wall 122 of the chamber 120 or to the lid 126).

The method further comprises maintaining the fluid within the interior 124 of the chamber 120 at the target temperature to incubate the isothermal assay samples 10 positioned within the cartridge 154. Incubation can be performed for any desired period of time and, in certain embodiments, incubation time is set by a user using the controller 102 (e.g., an input region 204 thereof).

The method can further comprise capturing one or more images of the isothermal assay samples 10 secured and displayed within the cartridge 154 through a transparent portion of the outer wall of the chamber 120. The capturing of the images can be performed using an imaging device 160 of the system 100 operated, for example, by the controller 102. The imaging device 160 can be a camera. The imaging device 160 can be a scanner. The imaging device 160 can be any other suitable imaging device now known or hereinafter developed that would be useful with the system 100.

In certain embodiments, the images are timelapse images taken at a regular (and continuous) frequency for a set period of time. A user can establish the frequency of image capture and various other imaging options (e.g., autofocus, contrast, etc.) using the controller 102.

The method can further comprise processing the captured images using the controller 102 of the reaction system 100, for example, to obtain quantitative colorimetric data from the assay samples 10. In certain embodiments, the controller 102 comprises executable software stored therein (e.g., in non-transitory memory) configured to generate quantitative output from the captured images. In this manner, the images can be quantitatively analyzed in real-time or near-real-time. In certain embodiments, the software can be based on the understanding that colorimetric output is directly proportional to the pH change resulting from a LAMP reaction. As such, each sample 10 can be processed and labeled, and assigned a color index value based thereon to obtain a quantitative result of identified positive reactions.

Kits for performing a field-deployable isothermal amplification assay are also provided. In certain embodiments, the kit comprises any of the reaction systems 100 for isothermal amplification assays described herein and one or more assay sensors 10. The assay sensors 10 can comprise a paper-strip assay, a tube or liquid container assay, or both.

For example, and without limitation, the reaction system 100 can comprise a sample loading unit 150 for housing one or more assay samples 10, a controller 102 in electrical communication with a heater 106, a power supply 104 coupled with the heater 106, controller 102, or both the heater 106 and controller 102, and a chamber 120. The chamber 120 can comprise two or more outer walls 122 defining an interior 124 for holding fluid therein and an open top in communication with the interior 120, and a lid 126. The lid 126 can define at least a first inlet 128a in communication with the interior 124. The lid 126 can be configured to sealably seat over the open top of the chamber 120. The lid 126 can further comprise at least one area for supporting the controller 102. The first inlet 128a can be, for example, configured to receive the testing unit therethrough. In certain embodiments, at least a portion of the two or more outer walls of the chamber 120 is transparent (such that images can be taken of any samples 10 suspended within the interior 124 therethrough) and the heater 106 is positioned to heat fluid within the interior 124 of the chamber 120 and the one or more assay sensors.

### Certain Definitions

As used herein, the following terms and phrases shall have the meanings set forth below. Unless defined otherwise, all technical and scientific terms used herein have the same meaning as commonly understood to one of ordinary skill in the art.

The term “about” can allow for a degree of variability in a value or range, for example, within 10%, within 5%, or within 1% of a stated value or of a stated limit of a range. The term “substantially” can allow for a degree of variability in a value or range, for example, within 90%, within 95%, 99%, 99.5%, 99.9%, 99.99%, or at least about 99.999% or more of a stated value or of a stated limit of a range.

The terms “a,” “an,” or “the” are used to include one or more than one unless the context clearly dictates otherwise. The term “or” is used to refer to a nonexclusive “or” unless otherwise indicated.

In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

While the concepts of the present disclosure are illustrated and described in detail in the figures and descriptions herein, results in the figures and their description are to be considered as exemplary and not restrictive in character; it being understood that only the illustrative embodiments are shown and described and that all changes and modifications that come within the spirit of the disclosure are desired to be protected. Indeed, the numerous specific details provided are set forth to provide a thorough understanding of the present disclosure.

Any use of section headings is intended to aid reading of the document and is not to be interpreted as limiting. Further, information that is relevant to a section heading may occur within or outside of that particular section.

All patents, patent application publications, journal articles, textbooks, and other publications mentioned in the specification are indicative of the level of skill of those in the art to which the disclosure pertains. All such publications are incorporated herein by reference to the same extent as if each individual publication were specifically and individually indicated to be incorporated by reference. In the event of inconsistent usages between this document and those documents so incorporated by reference, the usage in the incorporated reference should be considered supplementary to that of this document; for irreconcilable inconsistencies, the usage in this document controls.

Various techniques and mechanisms of the present disclosure will sometimes describe a connection or link between two components. Words such as attached, linked, coupled, connected, tethered and similar terms with their inflectional morphemes are used interchangeably, unless the difference is noted or made otherwise clear from the context. These words and expressions do not necessarily signify direct connections but include connections through mediate components. It should be noted that a connection between two components does not necessarily mean a direct, unimpeded connection, as a variety of other components may reside between the two components of note. Consequently, a connection does not necessarily mean a direct, unimpeded connection unless otherwise noted.

### EXAMPLES

The following examples serve to illustrate the present disclosure. The examples are not intended to limit the scope of the claimed invention in any way.

### Example 1

### Preparation of the Reaction System and Assay Testing

A transparent container of 12.8″×10.4×6″ (B00D0QSWX8, Carlisle) was used to hold the water. The lid comprised a base, control system container, a plate to hold the heating rod and a cover with a sample hanging slot, configured as shown in FIGS. 3A-3I (3D model prepared using Autodesk Fusion 360).

The test base of the lid was made with plywood coated with a waterproof solution. A Trotec Speedy 400 Laser Cutter to cut out the base from a 24″×24″×0.25″ plywood board (5420278, Ace Hardware). The control system container was made with Raise 3D printer using acrylonitrile butadiene styrene (ABS) filament (B08CC7QFXM, NovaMaker). The plate and the sample loading cover were fabricated with Formlabs Form 3+ Stereolithography (SLA) 3D printer using High Temp Resin V2 (RS-F2-HTAM-02, Formlabs).

To insert the tubes containing DNA samples inside the water bath, multiple sample holders were fabricated with Rigid 4000 VI Resin (RS-F2-RGWH-01RS, Formlabs) using the same SLA 3D printer, which is suitable for paper-based and liquid-based LAMP reactions. A orf7ab.I primer mix was used to prepare the master mix for detecting the orf7ab segment of SARS-COV-2 genome. Davidson et al., A paper-based colorimetric molecular test for SARS-COV-2 in saliva, Biosensors & Bioelectronics X9: 100076 (2021).

A synthetic DNA target was used for this segment for ease of handling. The concentration for the orf7ab DNA was 106 copies per reaction for the liquid colorimetric LAMP and 5×10⁶ copies per reaction for the paper-based colorimetric LAMP. The sample holders for carrying paper LAMP samples from the side and bottom of the water bath are shown in FIGS. 3F and 3G, respectively, whereas FIGS. 3H and 3I show the sample holders for holding small tubes which can carry both paper and liquid LAMP samples from the side and bottom, respectively.

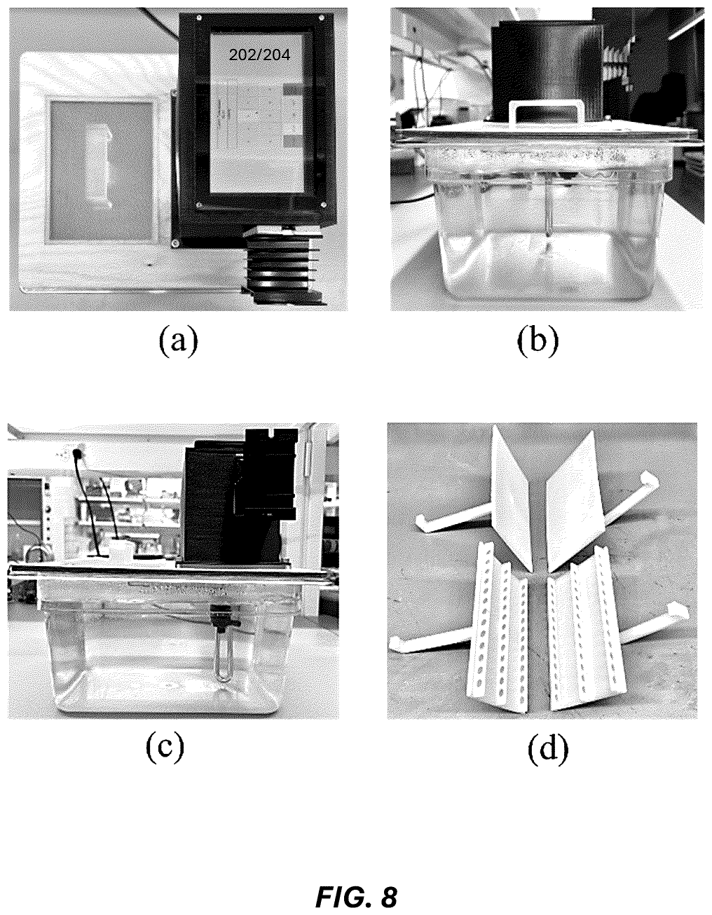

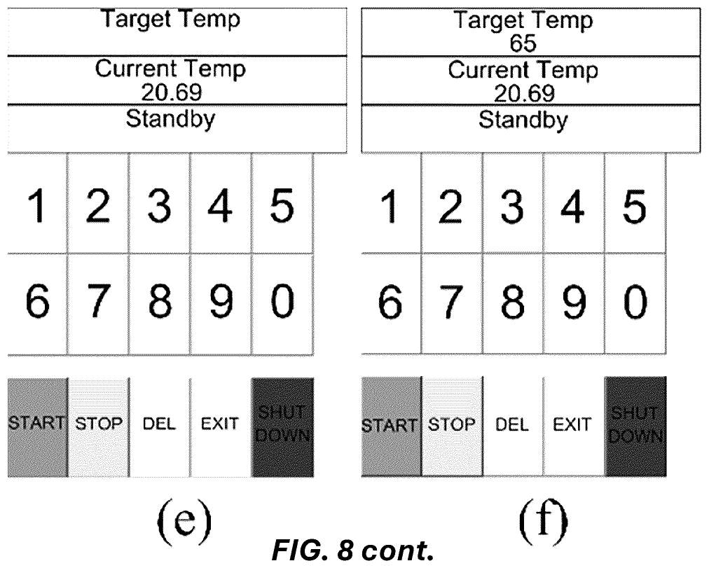

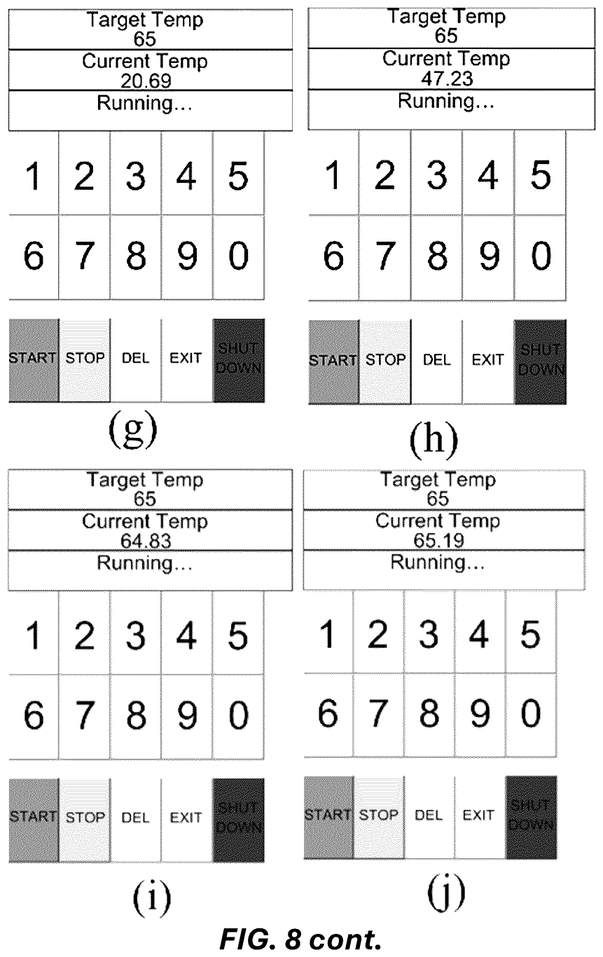

A submergible rotary motor was used to circulate the water within the chamber and maintain a uniform temperature all over the water bath. Moreover, a touchscreen LCD display connected to the microcontroller displayed the current temperature of the water and allowed the user to set a target temperature and start/stop the heating process (FIG. 8A). The final images of the device are shown in FIGS. 8A-8J and screenshots of the software operations of the system are shown in FIGS. 8E-8J.

A power supply unit to run the electronic components and the heater was added. The heater was directly connected to a 120V AC power outlet, whereas an AC-DC converter (B0BB8YWBHX, Diann) and a DC-DC buck module (B01HXU1NQY, HiLetgo) were connected in series to convert the 120V AC supply to 6V DC and supply power to the Raspberry Pi controller. All other electronic components were powered by the Raspberry Pi.

### Example 2

### Temperature Fluctuations from the Target Temperature

The typical heating temperature for LAMP is 65° C. Davidson et al. (2021), supra; Mohan et al. (2021), supra; Parida et al. (2008), supra; Pascual-Garrigos et al. (2021), supra; Safavieh et al., High-throughput real-time electrochemical monitoring of LAMP for pathogenic bacteria detection, Biosensors & Bioelectronics 58:101-106 (2014); Velders et al., Loop-mediated isothermal amplification (LAMP) shield for Arduino DNA detection, BMC Research Notes 11:1-5 (2018); Wan et al., LampPort: a handheld digital microfluidic device for loop-mediated isothermal amplification (LAMP), Biomedical Microdevices 21:1-8 (2019); Wang et al., A loop-mediated isothermal amplification assay to detect Bacteroidales and assess risk of fecal contamination, Food Microbiology 110:104173 (2023), Wang et al., Fabrication of a paper-based colorimetric molecular test for SARS-CoV-2, MethodsX 8:101586 (2021), Wang et al., Paper-based biosensors for the detection of nucleic acids from pathogens, Biosensors 12:1094 (2022), Wang et al., An integrated microfluidic loop-mediated-isothermal-amplification system for rapid sample pretreatment and detection of viruses, Biosensors & Bioelectronics 26:2045-2052 (2011); Zhang et al., LAMP-on-a-chip: Revising microfluidic platforms for loop-mediated DNA amplification, TrAC Trends in Analytical Chemistry 113:44-53 (2019). Therefore, the heating efficiency of the water bath of the reaction system of Example 1 was measured by setting 65° C. as the target temperature. The heater was tested in an environment set to room temperature (21° C.) and the heating was observed. The water bath was also tested in different environments, such as inside a refrigerator (5° C.) and outdoors on a hot day (33° C.).

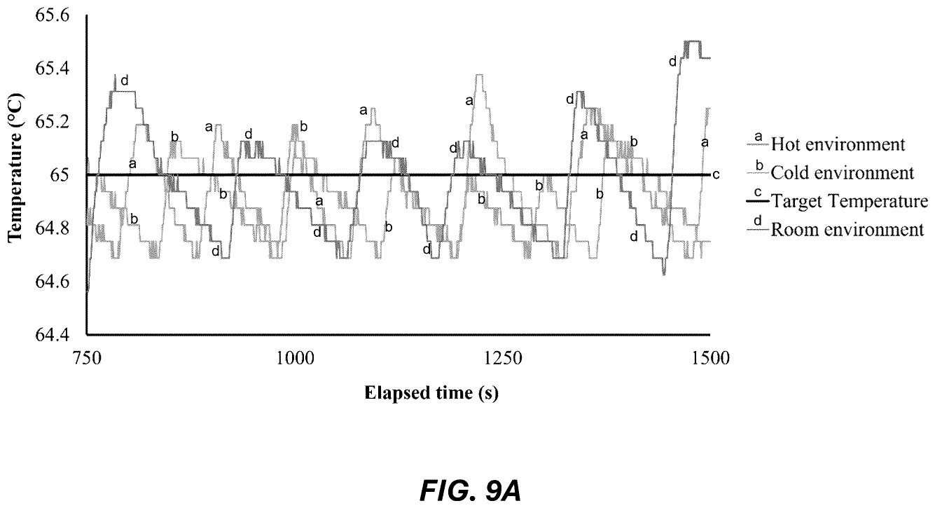

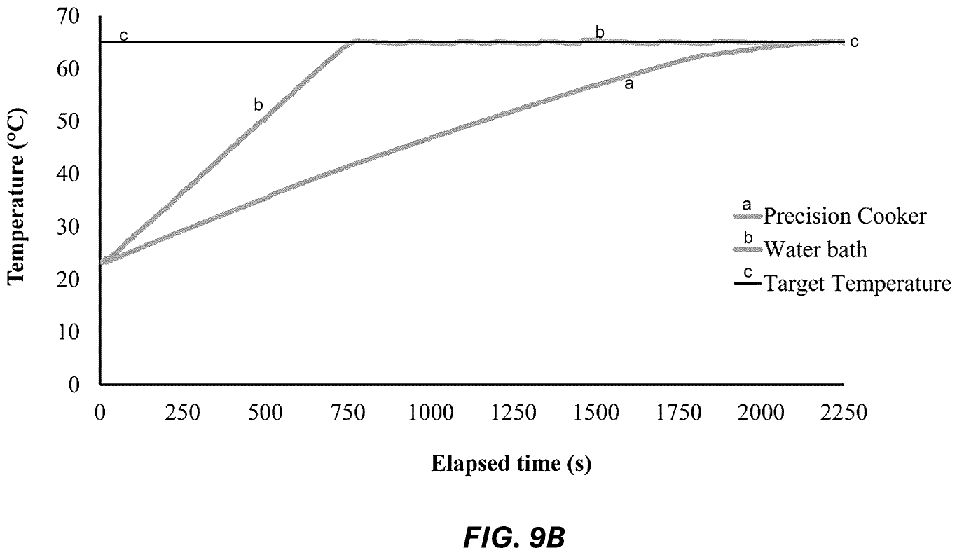

FIG. 9A shows the measured temperature curves with time in the three different environments. Considering the temperature curve from the aforementioned three environments, the temperature fluctuation in these environments was no greater than ±0.5° C. and the reaction system's performance was not dependent on (or effected by) the external environment.

### Example 3

### Validation of Temperature

After reaching the target temperature initially, the controller of the reaction system of Example 1 was able to maintain the temperature by toggling the heater on and off. The validity of the projected temperature was then validated using an Hti HT-04 Thermal Imaging Camera. As mentioned in the Example 2, when the temperature was set to 65° C., the fluctuation was within +0.5° C. Infrared images of different points of the water bath were taken with the thermal imager.

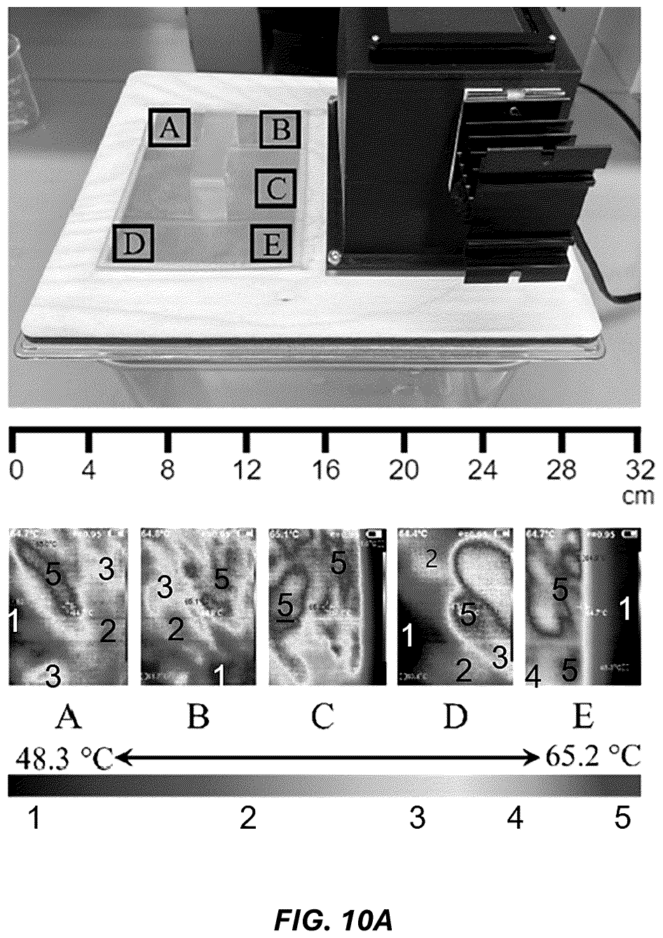

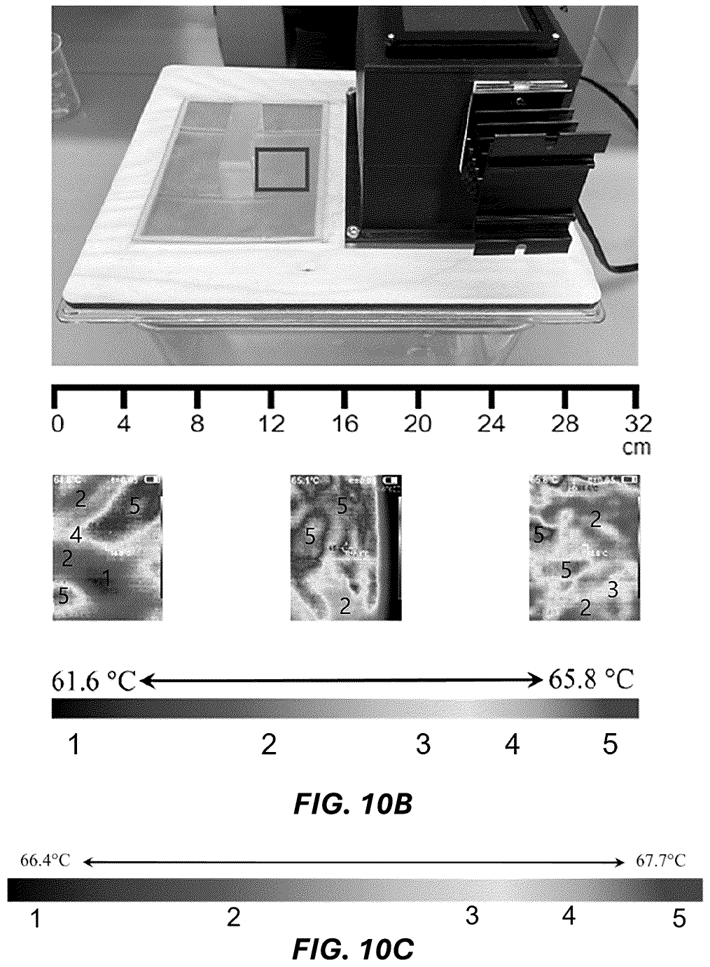

FIG. 10A illustrates the thermal images of various points when the target temperature was set to 65° C. The minimum and maximum observed temperatures through the thermal imager were 64.4° C. and 65.1° C., respectively.

FIG. 10B shows the infrared (IR) images of a single point over time, where the lowest detected temperature was 64.8° C. and the highest temperature was 65.8° C. Since the thermal imager had an error margin of ±1° C. and a thermal sensitivity of 0.07° C., the thermal images confirmed the temperatures recorded by the temperature sensor in the water bath.

### Example 4

### Visual Observation of LAMP Assays

The primary objective was to develop a water bath heater that can be used to heat the colorimetric loop-mediated isothermal amplification (LAMP) assay samples and illustrate visible results. Both paper-based and liquid-based colorimetric LAMP assays were performed using the water bath and received satisfactory results. In paper based colorimetric LAMP, the samples are added to a paper-device, whereas an individual domed PCR tube holds the samples in liquid-based colorimetric LAMP. Davidson et al. (2021), supra; Wang et al. (2023), supra.

A DNA target was used for simpler handling as compared to RNA that is naturally found in SARS-COV-2. Before placing the sample inside the water bath, the reaction system was turned on by connecting it to the power port and the controller used to set the target temperature to 65° C. It took about 12 minutes to reach 65° C. in the chamber when the water chamber was filled with water to its capacity of 6 liters.

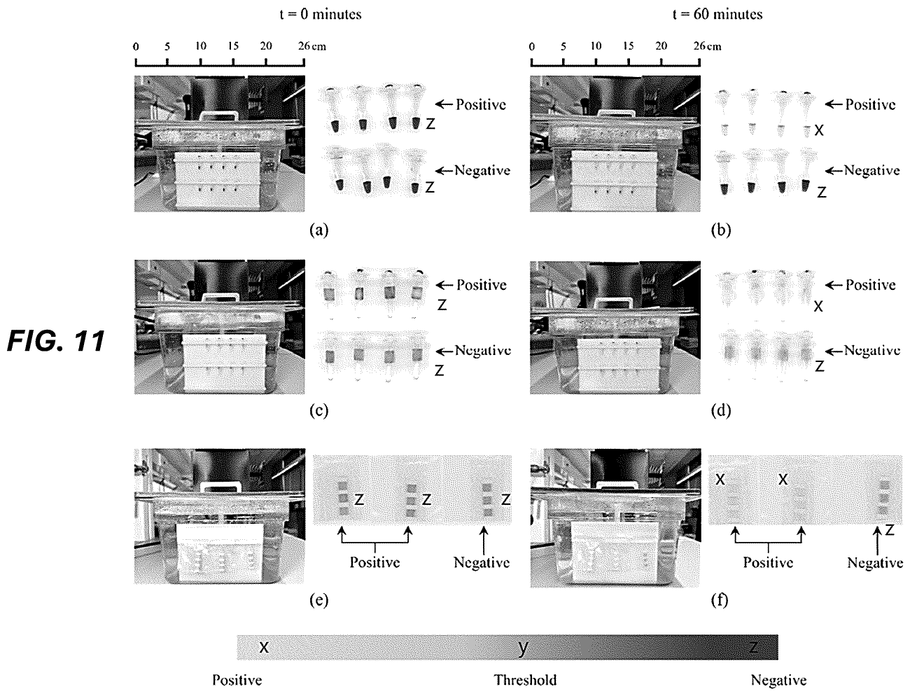

When the water reached the target temperature, the samples were loaded in the 3D printed sample holders and placed inside the water bath. FIGS. 11A and 11B and FIGS. 11C and 11D show the heating and color change of the samples for liquid-based and paper-based colorimetric LAMP, respectively, where the sample holder compatible for the liquid-based LAMP was used as well as paper-based LAMP.

FIGS. 11E and 11F show the heating of paper-based LAMP, where the samples were placed inside Ziploc bags and taped to the sample holders. This experimental setup was compatible with heating larger sizes of paper-based LAMP.

In all cases, visible color change was observed in the positive control samples after heating for 60 minutes, which indicated the presence of the specific nucleic acid. On the contrary, no colorimetric change occurred in the negative control samples even after the incubation. All results were visible observed through the transparent wall of the chamber while the samples remained submerged in the water bath.

### Example 5

### Comparison with Anova Precision Cooker

Based on the literature, common heating equipment used for heating LAMP assays in the field is a sous vide precision cooker or sous vide immersion heater. Davidson et al. (2021), supra; Kellner et al. (2020), supra; Pascual-Garrigos et al. (2021), supra; Wang et al. (2023), supra; Petzer et al., Rapid and simple colorimetric loop-mediated isothermal amplification (LAMP) assay for the detection of Bovine alphaherpesvirus 1, J Virological Methods 289:114041 (2021). The reaction system of Example 1 (“IsoHeat”) and the conventional Anova sous vide precision cooker (control; Anova Applied Electronics, Inc., San Francsico, CA) were tested in identical environments for comparison purposes.

FIG. 9B exhibits the temperature curve over time when 6L water was heated using the two devices. The reaction system of Example 1 took about 12 minutes to reach the target temperature (65° C.) for the first time, whereas the control precision cooker took around 36 minutes to reach the same temperature.

Moreover, the accuracy of water temperature heated with the precision cooker was also questionable. 10C presents the IR images of the water heated with the control precision cooker after reaching the target temperature of 65° C. On the other hand, temperature fluctuation in the IsoHeat is shown in FIG. 10A, when the target temperature was set to 65° C.

Even though the IsoHeat was more time efficient and exhibited higher accuracy than the control precision cooker, IsoHeat was less expensive to fabricate and did not require modification for inclusion of a transparent wall for viewing the submerged samples. The control precision cooker was around $150 to purchase with an additional cost of $12 required to create the heating setup using the commercially available transparent container.

### Example 6

### Isothermal Heater & Imager for Real-Time Quantification of Colorimetric Reactions

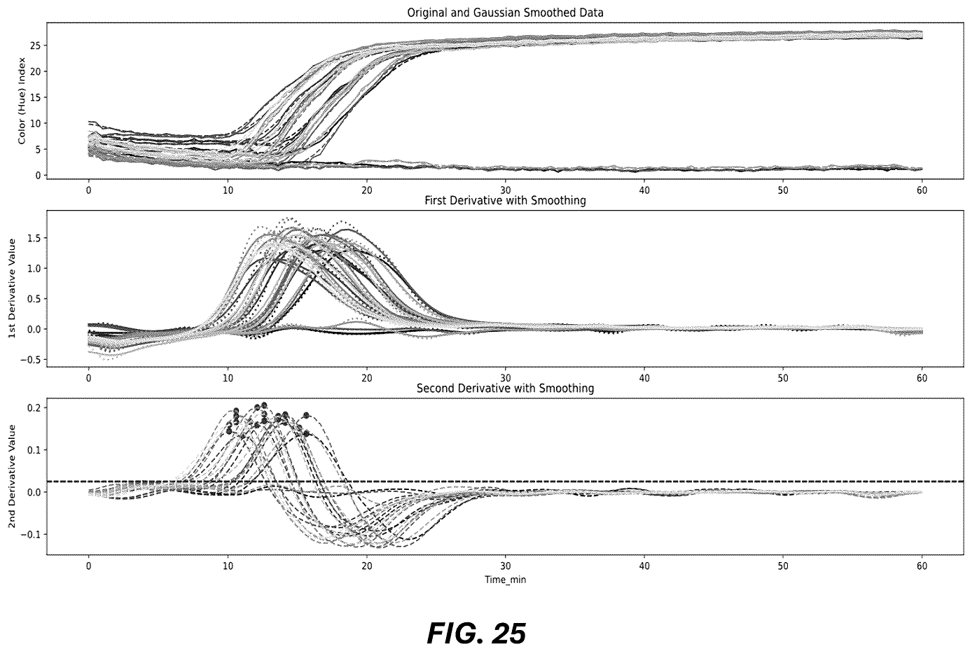

A waterproof cartridge was developed for running LAMP assays in paper-based devices at 65 ° C. (149° F.). Hardware design, experimental protocol, and software logics (FIG. 25) for running the LAMP reactions in both paper-based device and PCR tubes are also discussed.

4 different variations of the isothermal heater and imager were assessed; however, it will be understood that other embodiments are possible and will be understood in view of the present disclosure and results provided herein. The resulting systems were field tested, and it was validated that they can be used for point-of-need disease diagnosis.

LAMP reactions require a constant and specific temperature to amplify nucleic acids (usually around 65° C.). In colorimetric LAMP reactions, the amplification is indicated with continuous color change of the samples. Therefore, field deployable reaction systems were prepared that heated the LAMP reaction samples at a constant temperature for 60 minutes and provided quantitative output of the samples by capturing and processing images at 1-minute intervals.

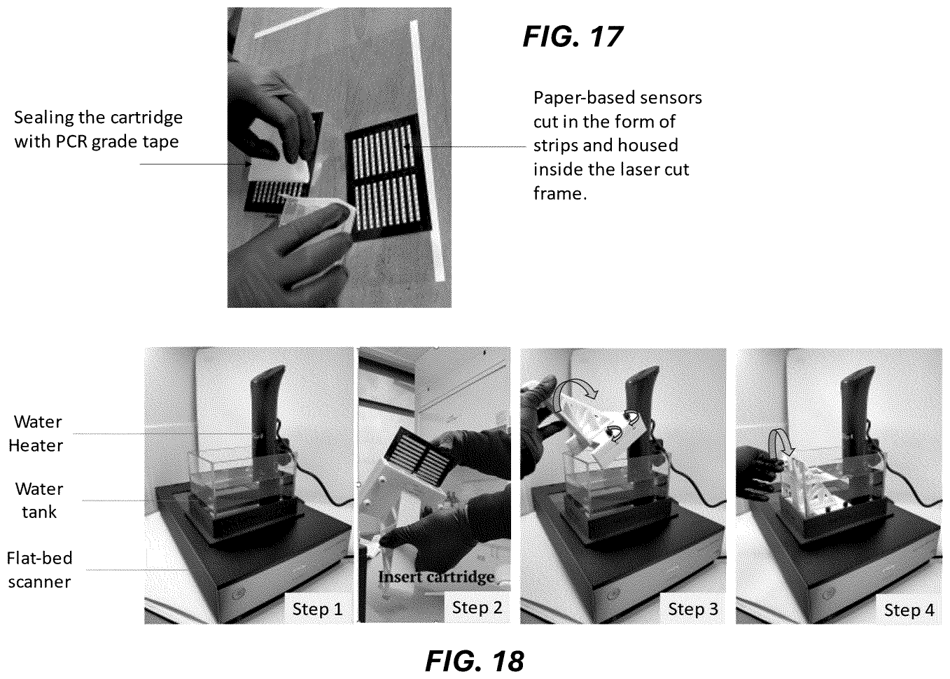

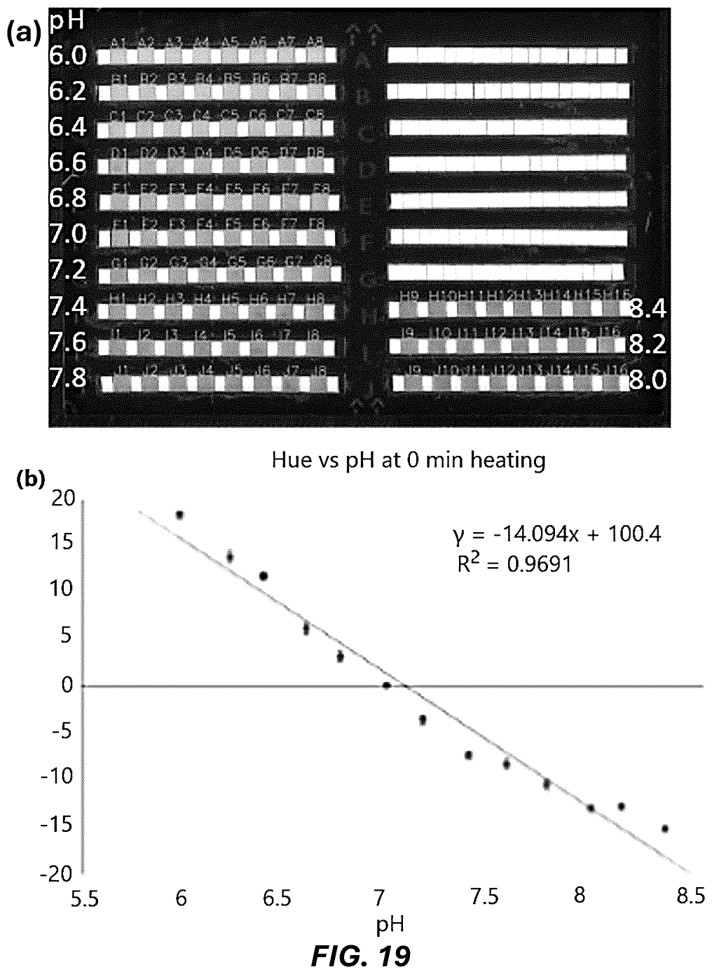

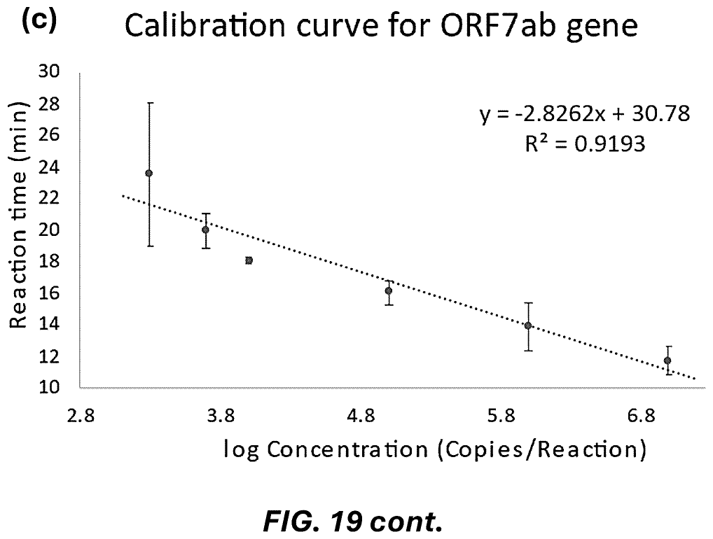

Primarily, a cartridge was fabricated for use with a system of Example 1, modified as described below. The cartridge was a leak-proof cartridge for paper-based sensors/assays. An acrylic panel (thickness=1.5 mm) was cut using a CO₂ laser cutter to a preconfigured size and shape. PCR-grade tape was attached to one face of the acrylic frame. Paper sensors were prepared in the form of strips with multiple reaction pads and were loaded on the acrylic frame from the opposite face. A second tape was applied to seal both the paper sensor and the acrylic frame (FIG. 17).

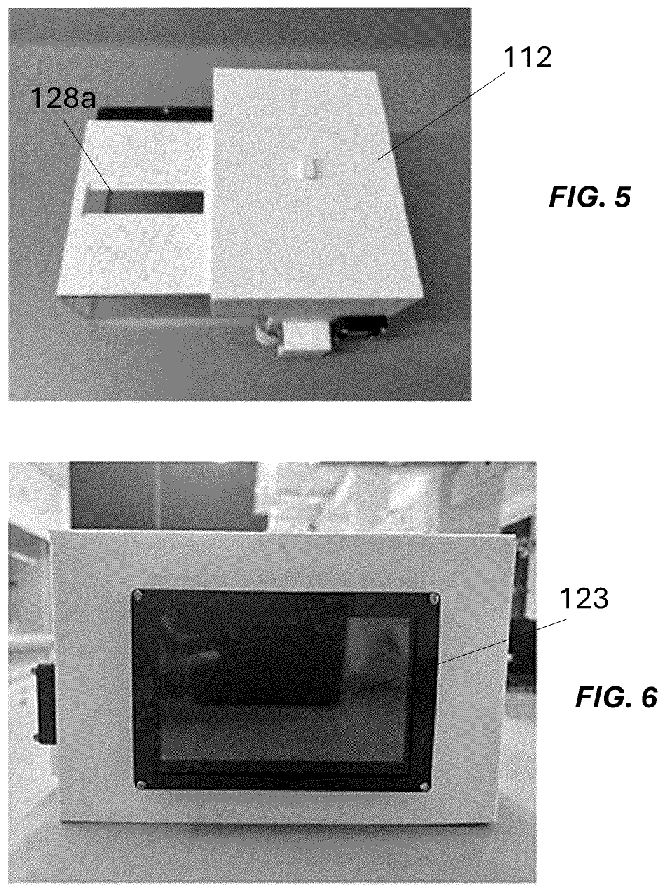

For the first assay, the system of Example 1 was modified to include an imaging device comprising a Raspberry Pi camera with autofocus capability, an LCD touch screen display (coupled with the controller) for displaying results, and a backlight positioned to illuminate the interior of the water bath/chamber. The camera was configured and positioned to take images of the samples when submerged in the water bath via the sample holder. FIGS. 4-7C and FIG. 20 show images of the resulting system.

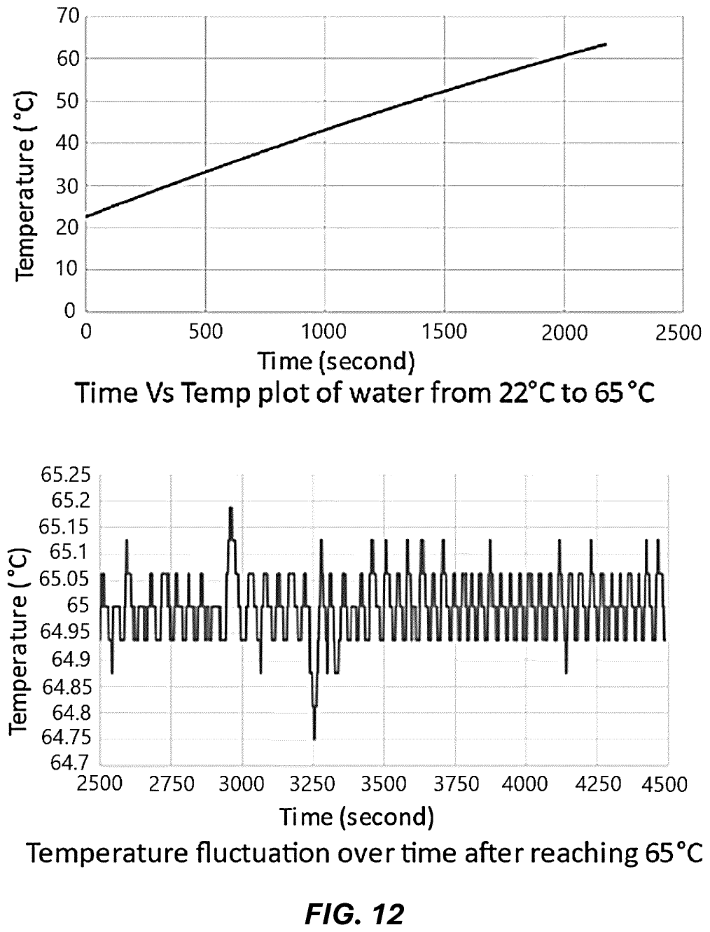

The modified system was used to heat the water to 65° C. and thereafter maintain that set temperature. FIG. 12 shows temperature data measured therefrom.

Paper samples were loaded into the acrylic frame as described above (FIG. 20) and the acrylic frame was submerged inside the water chamber using the holder shown in FIGS. 7B and 7C, the camera of the system captured images during the 60 minutes the samples incubated, and the images were processed on a Raspberry Pi 4B single board computer to provide the positivity percentage of the processed samples based on the colorimetric data. Custom python script was run to obtain timelapse images and generate quantitative output from the obtained images.

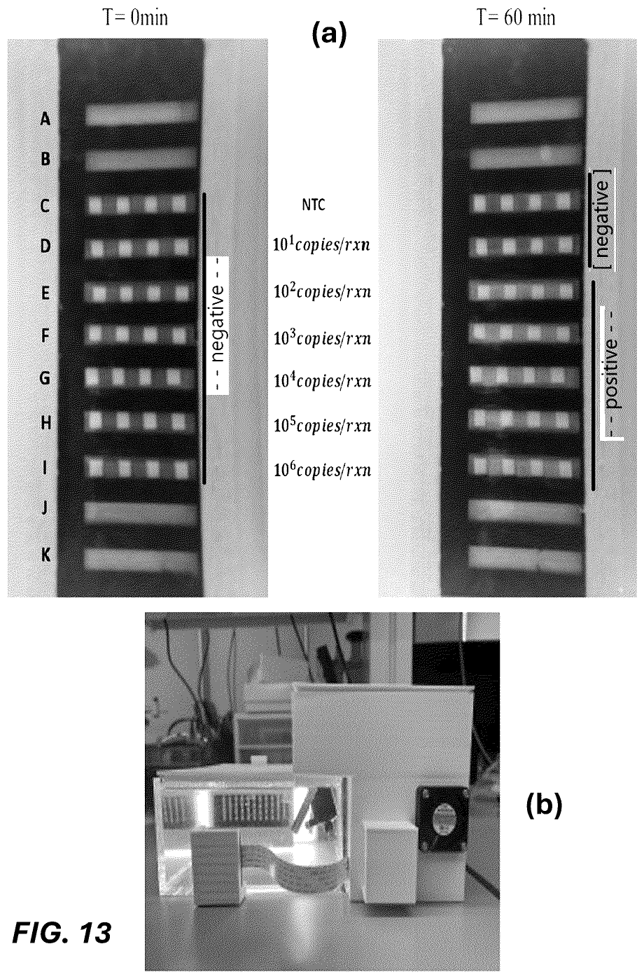

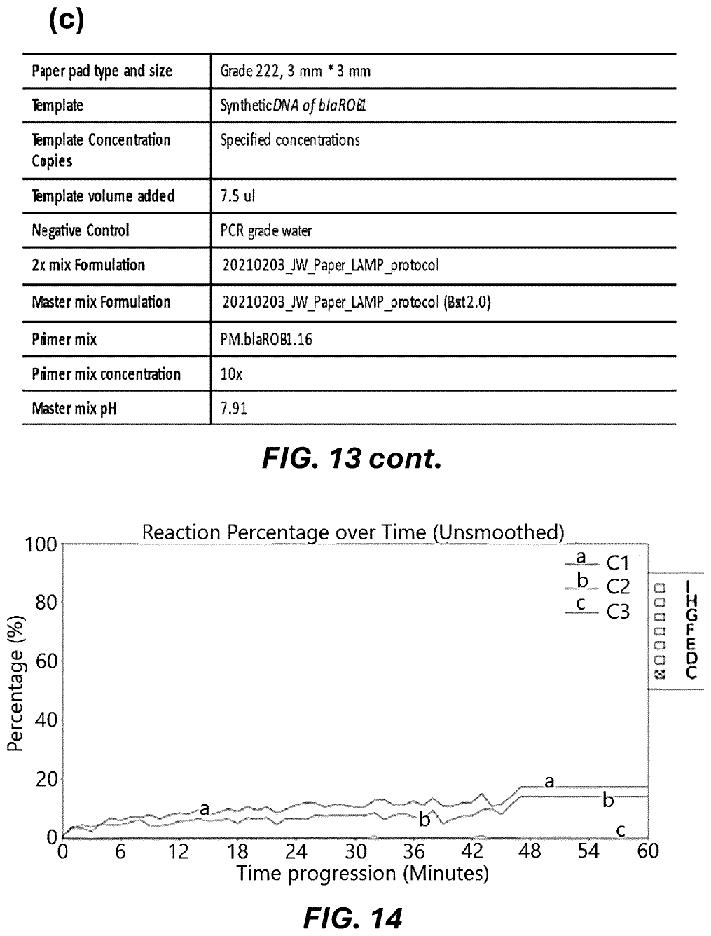

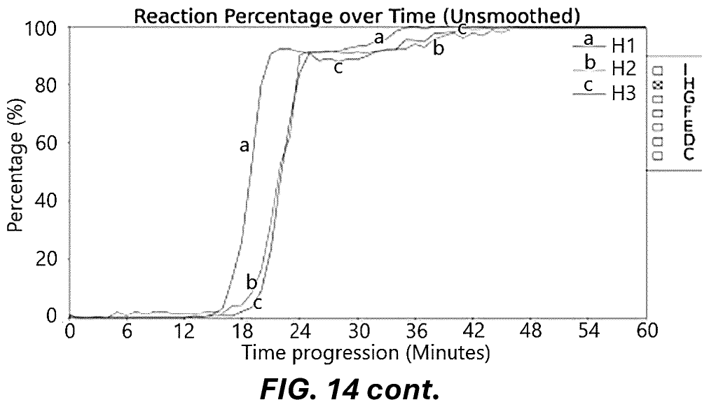

FIG. 13 shows images of the reacted samples taken using the imaging device and quantitative results calculated, as well as an image of the system and the assay parameters used. FIG. 14 shows graphical data to view quantitative output calculated of position C of the assay (top) and position H of the assay (bottom), which had three replicates of 10⁵ copies/reaction.

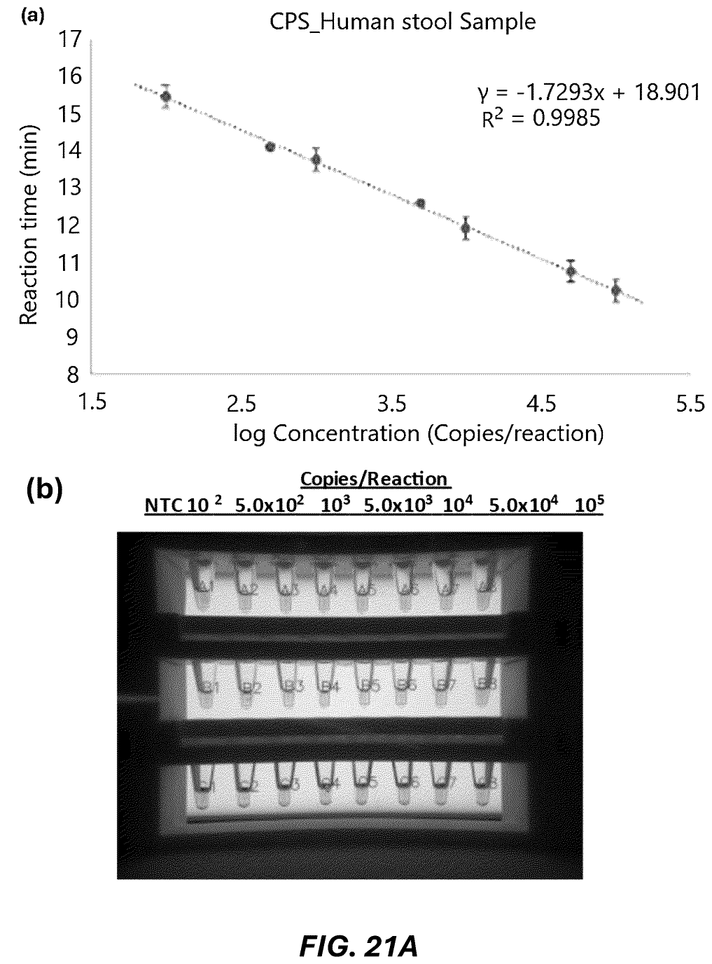

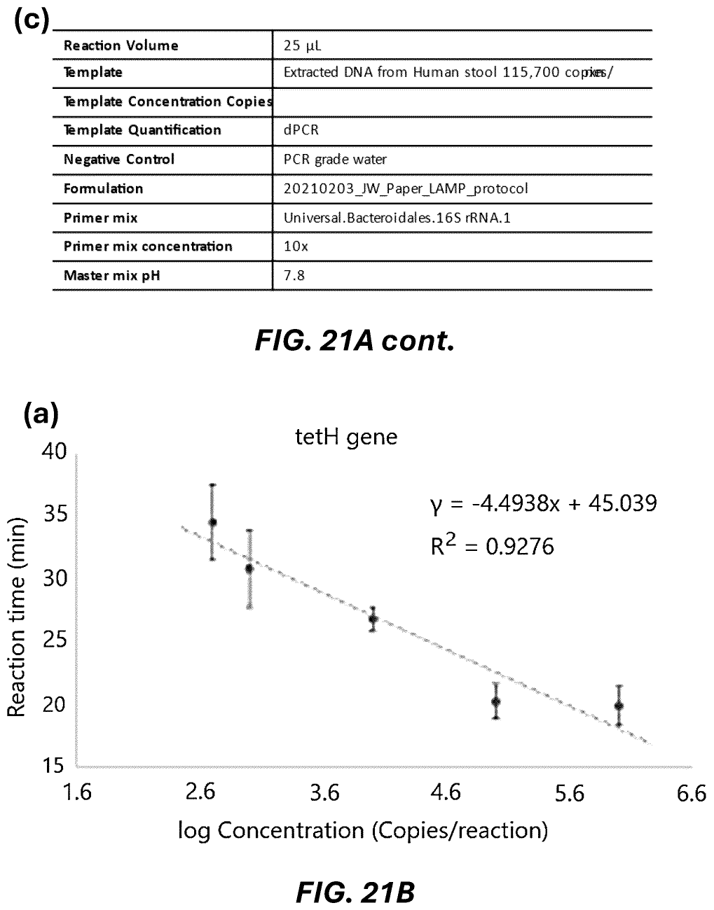

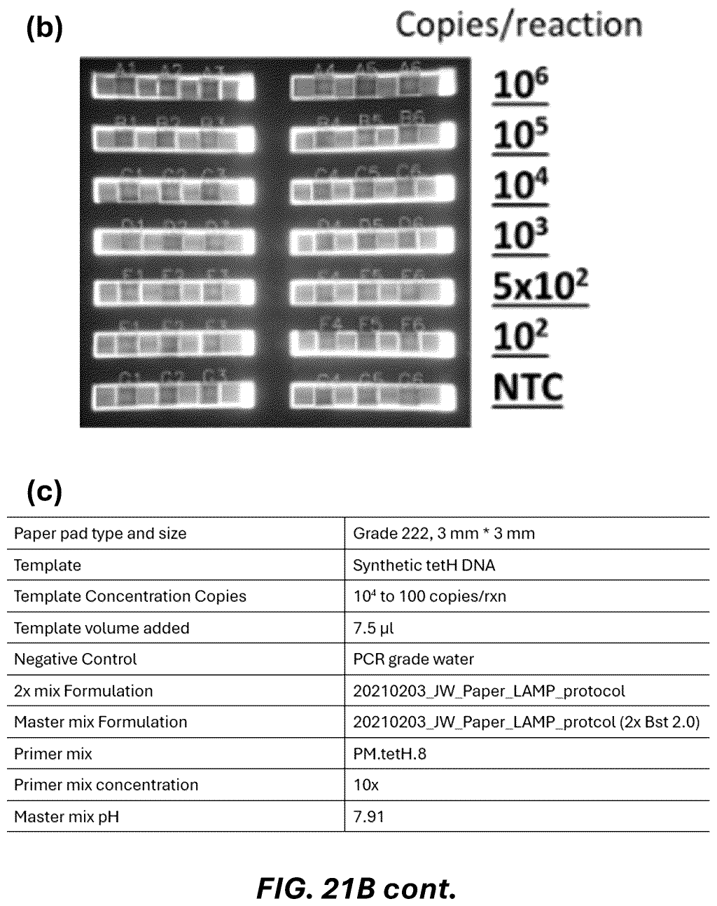

The same system was then used with an acrylic frame modified to hold tube/liquid-assays to validate that the backlight setup works for both tube and paper-based reactions. Two different studies were performed (parameters of each in FIGS. 21A and 21B, respectively), using the system and steps outlined above. Tube images were taken and further trained using a YOLOv8 framework to automatically segment the tube from each image. A linear calibration curve was obtained based on hue color index evaluation with respect to the starting reaction mixture as compared to color change over time to obtain a quantitative output (FIGS. 21A-21B).

Next, the system described above was modified to include an imaging device comprising a flatbed EPSON scanner connected to a desktop computer, and an isothermal heater arranged on top of the scanner (not submerged in the water bath). The chamber bottom was transparent and both the heater and chamber were positioned on top of the scanner next to each other. The scanner was configured to take images of the samples when submerged in the water bath via the sample holder. FIG. 18 shows images of the resulting system.

The modified system was used to heat the water to 65° C. and thereafter maintain that set temperature.

Paper samples were loaded (FIG. 17) into a leak-proof acrylic cartridge holder and the holder was submerged inside the water chamber. The holder was secured to the chamber's inside surface of a side wall and the scanner was used to continuously obtain timelapse images. The images were processed on a Raspberry Pi 4B single board computer to provide the positivity percentage of the processed samples based on the colorimetric data. Custom python script was run to obtain timelapse images and generate quantitative output from the obtained images.

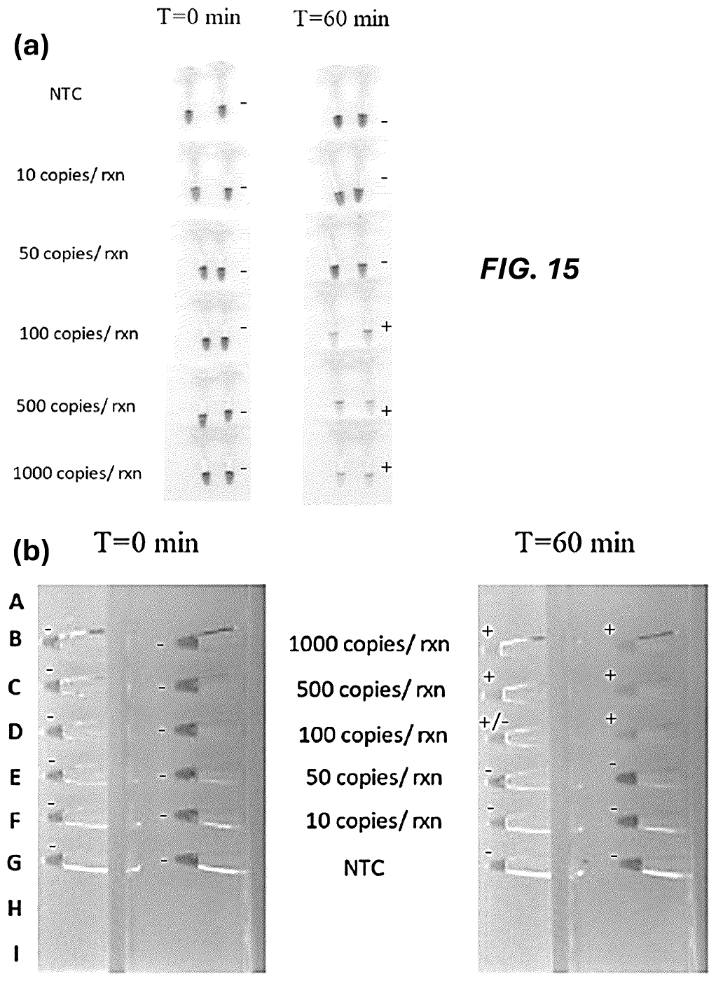

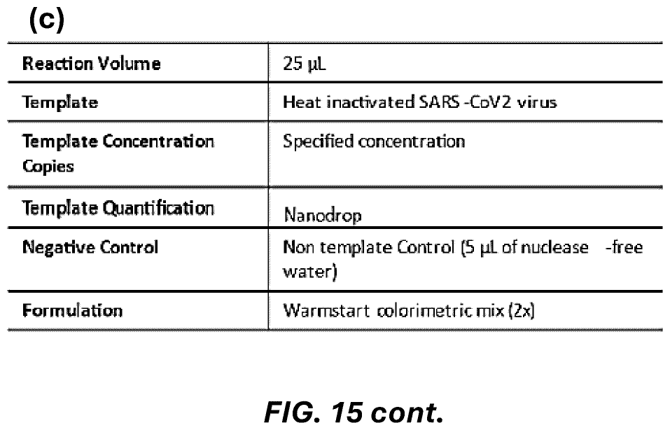

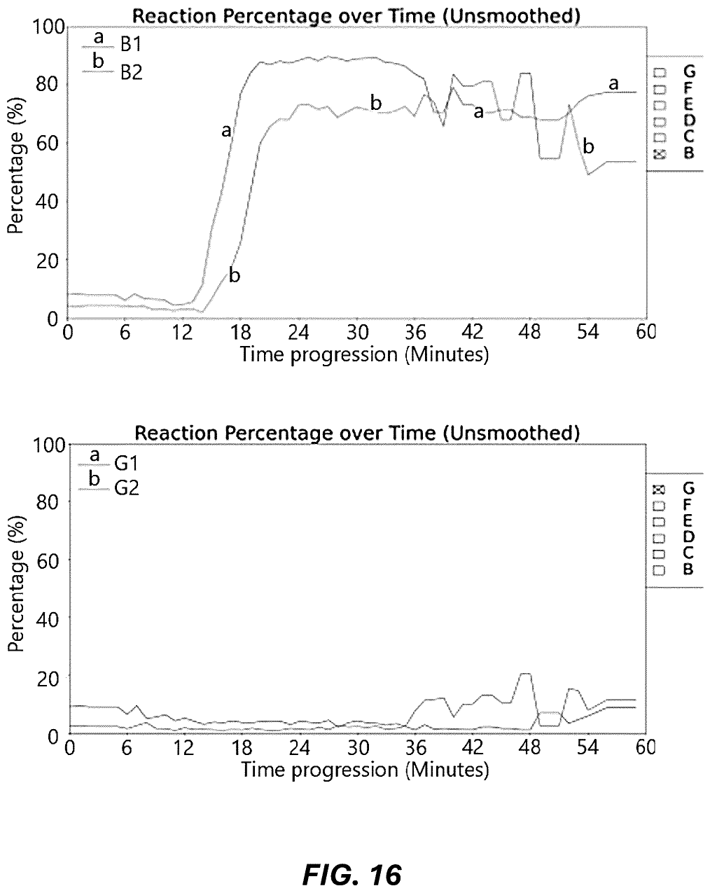

FIG. 15 shows images of the reacted samples taken using the imaging device and quantitative results calculated, as well as an image of the system and the assay parameters used. FIG. 16 shows graphical data to view quantitative output calculated of position B of the assay (top) which had two replicates of 1000 copies/reaction and position G of the assay (bottom), which had two replicates of negative control (NTC).

For the third study, the system of Example 1 was modified to include an imaging device comprising a Raspberry Pi camera with autofocus capability, an LCD touch screen display (coupled with the controller) for displaying results, and a backlight positioned to illuminate the interior of the chamber. The interior of the chamber was not filled with water; instead, the heater of the system was an Indium Tin oxide (ITO) coated glass heater, and the chamber was placed on the ITO heating surface. The camera was configured and positioned to take images of the samples when positioned within the interior of the chamber via the sample holder. The backlight was configured to illuminate the sensors in the sample holder and the color change thereof was tracked through timelapse images taken using the camera placed opposite the backlight light source. FIG. 22 show models and an image of the resulting system.

The modified system was used to heat the interior of the chamber to 65° C. and thereafter maintain that set temperature.

Paper samples were loaded (FIG. 17) into a leak-proof acrylic cartridge holder and the holder was positioned inside the chamber. The holder was secured to the chamber's inside surface of a side wall and the camera was used to continuously obtain timelapse images. The images were processed on a Raspberry Pi 4B single board computer to provide the positivity percentage of the processed samples based on the colorimetric data. Custom python script was run to obtain timelapse images and generate quantitative output from the obtained images.

For the fourth study, the system of the third study was modified such that the imaging device was a camera, and the system further included a photodiode color sensor configured to measure color change during the reaction in real-time. It is contemplated that the photodiode color sensor could also be used without a separate imaging device to reduce the overall size of the system such that it will be comparable in size to that of a smartcard reader/regular smartphone (i.e. to be used as a handheld device).

The photodiode color sensor was positioned below the cartridge containing the paper-based assays (described above) and aligned to each reaction on the paper pads. A rechargeable LiPo battery was used as backup power for use in cases where electricity was not immediately available. FIG. 23 shows a schematic of the resulting system (scale 1 cm).

The modified system was used to heat the interior of the chamber to 65° C. and thereafter maintain that set temperature.

Paper samples were loaded (FIG. 17) into a leak-proof acrylic cartridge holder and the holder was positioned inside the chamber. The photodiode color sensor was used to continuously obtain timelapse images. The images were processed on a Raspberry Pi 4B single board computer to provide the positivity percentage of the processed samples based on the colorimetric data. Custom python script was run to obtain timelapse images and generate quantitative output from the obtained images.

The graphical user interface shown in FIG. 24 was used with all four above-described systems (with slight variations) to facilitate user interaction and image processing to obtain and display the quantitative results in each study.

The results support that the system maintained 65° C. throughout the water and was capable of heating the LAMP samples (in both paper and tube-based assays), allowed the users to observe the continuous color change of the samples with the naked eye, allowed images to be captured of the samples throughout the heating/incubation process, and provided quantitative data calculated based on the color changes of the samples measured/observed during incubation.

1. A reaction system for isothermal amplification assays, the reaction system comprising:
a sample loading unit for housing one or more assay samples;
a controller in electrical communication with a heater;
a power supply coupled with the heater, controller, or both the heater and controller; and
a chamber comprising:
two or more outer walls defining an interior for holding fluid therein and an open top in communication with the interior, and
a lid defining at least a first inlet in communication with the interior, wherein the lid is configured to seat over the open top of the chamber and further comprises at least one area for supporting the controller,
wherein the first inlet is configured to receive at least a portion of the sample loading unit therethrough, at least a portion of the two or more outer walls is transparent, and the heater is positioned to heat fluid within the interior of the chamber.

2. The reaction system of claim 1, wherein the heater is an immersion heating device, the fluid is water, and the lid further comprises a second inlet in communication with the interior and configured to receive at least a portion of the heater therethrough.

3. The reaction system of claim 1, wherein the heater comprises a solid-state heater and the fluid is air.

4. The reaction system of claim 1, wherein the sample loading unit comprises a handle coupled with a cartridge comprising one or more sample holders, each sample holder configured to receive, secure, and display an assay container or paper strip assay therein.

5. The reaction system of claim 4, further comprising an imaging device positioned to capture images of the one or more sample holders through the transparent outer wall portion when the sample loading unit is inserted into the interior of the chamber via the first inlet.

6. The reaction system of claim 1, herein the lid further comprises a housing for encasing at least the controller.

7. The reaction system of claim 1, further comprising a submergible circulator or fan configured to circulate fluid within the interior of the chamber.

8. The reaction system of claim 1, wherein the lid is hingedly coupled with at least one of the two or more outer walls of the chamber, or integrally formed with at least one of the two or more outer walls of the chamber.

9. The reaction system of claim 1, wherein the controller comprises a microcontroller.

10. The reaction system of claim 9, wherein the controller further comprises a display and input region, each in communication with the microcontroller to display at least the current temperature of the interior of the chamber and enable a user to set a target temperature of fluid within the interior of the chamber.

11. The reaction system of claim 1, further comprising a temperature sensor in communication with the controller and for placement within the interior of the chamber.

12. The reaction system of claim 4, wherein the cartridge defines a substantially waterproof environment in which the one or more sample holders is housed.

13. Methods of performing an isothermal amplification assay comprising:
providing a reaction system for isothermal amplification assays, the reaction system comprising:
a sample loading unit for housing one or more assay samples, the sample loading unit comprising a handle coupled with a cartridge comprising one or more sample holders, each sample holder configured to receive, secure, and display an assay container or paper strip assay therein,
a controller in electrical communication with a heater,
a power supply coupled with the heater, controller, or both the heater and controller, and
a chamber comprising:
two or more outer walls defining an interior for holding fluid therein and an open top in communication with the interior, and
a lid defining at least a first inlet in communication with the interior, wherein the lid is configured to seat over the open top of the chamber and further comprises at least one area for supporting the controller,
wherein the first inlet is configured to receive at least a portion of the sample loading unit therethrough, at least a portion of the two or more outer walls is transparent, and the heater is positioned to heat fluid within the interior of the chamber;
activating the heater to heat fluid within the interior of the chamber to a target temperature;
inserting the cartridge of the sample loading unit into the interior of the chamber and fluid contained therein, wherein the cartridge secures and displays one or more paper-based or tube isothermal assays; and
maintaining the fluid at the target temperature to incubate the isothermal assays.

14. The method of claim 13, wherein the target temperature is 37-85 degrees Celsius, and the fluid is water or air.

15. The method of claim 13, wherein the target temperature is obtained within about 12 minutes from activating the heater.

16. The method of claim 13, wherein the method further comprises capturing timelapse images through a transparent portion of the outer wall of the chamber of the isothermal assays secured and displayed within the cartridge using an imaging device.

17. The method of claim 16, further comprising processing the timelapse images using the controller of the reaction system to obtain quantitative colorimetric data from the assays.

18. A kit for performing a field-deployable isothermal amplification assay, the kit comprising:
a reaction system for isothermal amplification assays, the reaction system comprising:
a sample loading unit for housing one or more assay samples, the sample loading unit comprising a handle coupled with a cartridge comprising one or more sample holders, each sample holder configured to receive, secure, and display an assay container or paper strip assay therein,
a controller in electrical communication with a heater,
a power supply coupled with the heater, controller, or both the heater and controller, and
a chamber comprising:
two or more outer walls defining an interior for holding fluid therein and an open top in communication with the interior, and
a lid defining at least a first inlet in communication with the interior, wherein the lid is configured to seat over the open top of the chamber and further comprises at least one area for supporting the controller,
wherein the first inlet is configured to receive at least a portion of the sample loading unit therethrough, at least a portion of the two or more outer walls is transparent, and the heater is positioned to heat fluid within the interior of the chamber; and
one or more assay sensors.

19. The kit of claim 18, wherein the assay sensor comprises a container for housing a liquid assay or a paper-strip assay.
